(19) United States
(12) Patent Application Publication
(10) Pub. No.: US 2025/0374412 A1
(43) Pub. Date: Dec. 4, 2025

(54) DUAL-MODE PLASMA GENERATION SYSTEM AND METHOD

(71) Applicant: FUSE ENERGY TECHNOLOGIES CORP., San Leandro, CA (US)

(72) Inventors: Vahid DAMIDEH, Québec (CA); Jean-Christoph BTAICHE, Québec (CA); Andy LIAO, Québec (CA)

(73) Assignee: FUSE ENERGY TECHNOLOGIES CORP., San Leandro, CA (US)

(21) Appl. No.: 18/873,680

(22) PCT Filed: Jun. 14, 2023
(86) PCT No.: PCT/US2023/068443

§ 371 Date: Dec. 10, 2024

Related U.S. Application Data
(60) Provisional application No. 63/352,254, filed on Jun. 15, 2022.
(60) Provisional application No. 63/352,258, filed on Jun. 15, 2022.

(51) Int. Cl. H05H 1/06; H05H 1/48; H05H 1/54

(52) U.S. Cl. CPC H05H 1/06; H05H 1/54; H05H 1/48

(57) ABSTRACT

A plasma generation system includes a plasma confinement device, a precursor supply unit, and a power supply unit. The plasma confinement device includes an inner electrode, an outer electrode, and an electrically insulating insert. The outer electrode surrounds the inner electrode to define an acceleration region therebetween, and extends longitudinally beyond the inner electrode to define an assembly region. The acceleration and assembly regions form a plasma chamber. The plasma generation system has a first and a second operation mode, wherein the insert is respectively removed from and inserted into the plasma chamber. In both modes, the precursor supply unit is configured to supply a plasma precursor in the plasma chamber and the power supply unit is configured to energize the plasma precursor into a Z-pinch plasma. In the second mode, the insert is configured to reduce a discharge volume of the plasma chamber to substantially exclude the acceleration region.

### RELATED PATENT APPLICATIONS

The present application claims priority to U.S. Provisional Patent Application No. 63/352,258 filed on Jun. 15, 2022 and U.S. Provisional Patent Application No. 63/352,254 filed on Jun. 15, 2022, the disclosures of which are incorporated herein by reference in their entireties.

### TECHNICAL FIELD

The technical field generally relates to plasma technology and, more particularly, to a dual-mode plasma generation system and method for use, for example, in nuclear fusion power applications.

### BACKGROUND

Nuclear fusion energy is energy produced by a nuclear fusion process in which two or more lighter atomic nuclei are joined to form a heavier nucleus whose mass is less than the sum of the masses of the lighter nuclei. The difference in mass is released as energy, which can be harnessed to produce electricity. Fusion reactors are devices whose function is to harness fusion energy. One type of fusion reactors relies on magnetic plasma confinement. Such fusion reactors aim to confine high-temperature plasmas to sufficiently high-density with prolonged stability. Non-limiting examples of magnetic plasma confinement approaches include Z-pinch-configurations, magnetic mirror configurations, and toroidal configurations, for example, the tokamak and the stellarator. In Z-pinch configurations, a plasma column with an axial current flowing through it generates an azimuthal magnetic field that radially compresses the plasma, resulting in an increase of the fusion reaction rate. Z-pinch reactors are attractive due to their simple geometry, absence of magnetic field coils for plasma confinement and stabilization, inherent compactness, and relatively low cost. Conventional Z-pinch reactors suffer from instabilities that limit plasma lifetimes. Research has found that stabilization of Z-pinch plasmas with a sheared flow can help reduce these instabilities, opening the possibility of producing and sustaining stable Z-pinches over longer timescales. Despite these advances, challenges remain in the field of Z-pinch-based plasma generation systems for use in fusion reactors as well as in various other fields and applications.

### SUMMARY

The present description generally relates to Z-pinch-based plasma generation systems with dual-mode operation.

In accordance with aspect, there is provided a plasma generation system including:
a plasma confinement device having a longitudinal axis and including:
   an inner electrode;
   an outer electrode surrounding the inner electrode and defining an acceleration region therebetween, the outer electrode extending beyond the inner electrode along the longitudinal axis to define an assembly region adjacent the acceleration region, the acceleration region and the assembly region forming a plasma chamber; and
   an electrically insulating insert configured for removable insertion in the plasma chamber;
a precursor supply unit coupled to the plasma chamber; and
a power supply unit coupled to the inner electrode and the outer electrode,
wherein the plasma generation system is configured for operation in a first operation mode and a second operation mode,
wherein, in the first operation mode:
   the electrically insulating insert is removed from the plasma chamber;
   the precursor supply unit is configured to supply a first plasma precursor in the acceleration region; and
   the power supply unit is configured to energize the first plasma precursor to cause a plasma flow to move along the acceleration region and into the assembly region and to be compressed into a first Z-pinch plasma extending along the longitudinal axis in the assembly region, and
wherein, in the second operation mode:
   the electrically insulating insert is inserted in the plasma chamber and arranged with respect to the inner electrode and the outer electrode to reduce an available discharge volume of the plasma chamber to substantially exclude the acceleration region;
   the precursor supply unit is configured to supply a second plasma precursor in the assembly region, within the available discharge volume of the plasma chamber; and
   the power supply unit is configured to energize the second plasma precursor into a second Z-pinch plasma extending along the longitudinal axis in the assembly region.

In some embodiments, the electrically insulating insert is made of a single integral body of electrically insulating material.

In some embodiments, the electrically insulating insert is made of multiple physically disconnected parts of electrically insulating material.

In some embodiments, the electrically insulating insert is configured, upon insertion in the plasma chamber, to contact an outer peripheral surface of the inner electrode.

In some embodiments, the electrically insulating insert is configured, upon insertion in the plasma chamber, to contact an inner peripheral surface of the outer electrode.

In some embodiments, the electrically insulating insert is configured, upon insertion in the plasma chamber, to contact both an outer peripheral surface of the inner electrode and an inner peripheral surface of the outer electrode.

In some embodiments, the electrically insulating insert is configured, upon insertion in the plasma chamber, to occupy an entirety of the acceleration region.

In some embodiments, the electrically insulating insert is configured, upon insertion in the plasma chamber, to occupy an entirety of the acceleration region and an outer portion of the assembly region.

In some embodiments, the electrically insulating insert is shaped as an annular cylinder. In some embodiments, the electrically insulating insert has an annular cross-section of constant thickness along its longitudinal length. In other embodiments, the electrically insulating insert has an annular cross-section of variable thickness along its longitudinal length.

In some embodiments, the electrically insulating insert includes a first annular segment and a second annular segment, wherein, upon insertion of the electrically insulating insert in the plasma chamber, the first annular segment is configured to occupy an entirety of the acceleration region and the second annular segment is configured to occupy an outer portion of the assembly region.

In some embodiments, an inner radius of the first annular segment is smaller than an inner radius of the second annular segment, and an outer radius of the first annular segment is equal to an outer radius of the second annular segment.

In some embodiments, the electrically insulating insert is made of a ceramic material, a glass material, a glass-ceramic material, a polymer material, or any combination thereof.

In some embodiments, the precursor supply unit is configured to supply the first plasma precursor in the acceleration region via one or more first precursor supply ports formed through a periphery of the inner electrode and/or a periphery of the outer electrode.

In some embodiments, the precursor supply unit is configured to supply the second plasma precursor in the assembly region via one or more second precursor supply ports formed through a front end of the inner electrode and/or a front end of the outer electrode.

In some embodiments, the first Z-pinch plasma and/or the second Z-pinch plasma have an embedded radially sheared axial flow.

In some embodiments, the first plasma precursor is a first precursor gas (e.g., a neutral or partially ionized gas or gas mixture), and the second plasma precursor is a second precursor gas (e.g., a neutral or partially ionized gas or gas mixture).

In some embodiments, the first plasma precursor is a first precursor plasma (e.g., a low-temperature plasma), and the second plasma precursor is a second precursor plasma (e.g., a low-temperature plasma).

In some embodiments, the first plasma precursor and the second plasma precursor include deuterium, tritium, hydrogen, helium, or any combination thereof.

In some embodiments, the plasma generation system further includes a neutral beam injection unit configured to generate a beam of neutral particles and inject the beam of neutral particles into the plasma chamber to heat and stabilize the first Z-pinch plasma, in the first operation mode, and the second Z-pinch plasma, in the second operation mode.

In accordance with another aspects, there is provided a method of controlling a plasma generation system having a first operation mode and a second operation mode, wherein the plasma generation system includes a plasma confinement device having a longitudinal axis and including an inner electrode, an outer electrode surrounding the inner electrode to define an acceleration region therebetween, the outer electrode extending beyond the inner electrode along the longitudinal axis to define an assembly region adjacent the acceleration region, the acceleration region and the assembly region forming a plasma chamber, and an electrically insulating insert configured for removable insertion in the plasma chamber; a precursor supply unit coupled to the plasma chamber; and a power supply unit coupled to the inner electrode and the outer electrode, the method including:
operating the plasma generation system in the first operation mode, wherein the electrically insulating insert is removed from the plasma chamber, the operating including:
   supplying, with the precursor supply unit, a first plasma precursor in the acceleration region; and
   energizing, with the power supply unit, the first plasma precursor supplied in the acceleration region to cause a plasma flow to move along the acceleration region and into the assembly region and to be compressed into a first Z-pinch plasma extending along the longitudinal axis in the assembly region;
operating the plasma generation system in the second operation mode, wherein the electrically insulating insert is inserted into the plasma chamber and arranged with respect to the inner electrode and the outer electrode to reduce an available discharge volume of the plasma chamber to substantially exclude the acceleration region, the operating including:
   supplying, with the precursor supply unit, a second plasma precursor in the assembly region, within the available discharge volume of the plasma chamber; and
   energizing, with the power supply unit, the second plasma precursor supplied in the assembly region into a second Z-pinch plasma extending along the longitudinal axis in the assembly region; and
switching between operating the plasma generation system in the first operation mode and operating the plasma generation system in the second operation by selectively inserting the electrically insulating insert into or removing the electrically insulating insert from the plasma chamber.

In some embodiments, the method further includes providing the electrically insulating insert as a single integral body of electrically insulating material.

In some embodiments, the method further includes providing the electrically insulating insert as multiple physically disconnected parts of electrically insulating material.

In some embodiments, inserting the electrically insulating insert in the plasma chamber includes disposing the electrically insulating insert in contact with an outer peripheral surface of the inner electrode.

In some embodiments, inserting the electrically insulating insert in the plasma chamber includes disposing the electrically insulating insert in contact with an inner peripheral surface of the outer electrode.

In some embodiments, inserting the electrically insulating insert in the plasma chamber includes disposing the electrically insulating insert in contact with both an outer peripheral surface of the inner electrode and an inner peripheral surface of the outer electrode.

In some embodiments, inserting the electrically insulating insert in the plasma chamber includes making the electrically insulating insert occupy an entirety of the acceleration region.

In some embodiments, the method further includes providing the electrically insulating insert as an annular cylinder.

In some embodiments, the method further includes providing the electrically insulating insert with a first annular segment and a second annular segment, wherein, upon insertion of the electrically insulating insert in the plasma chamber, the first annular segment is configured to occupy an entirety of the acceleration region and the second annular segment is configured to occupy an outer portion of the assembly region.

In some embodiments, operating the plasma generation system includes forming, in the first operation mode, the first Z-pinch plasma with an embedded radially sheared axial flow and/or forming, in the second operation mode, the second Z-pinch plasma with an embedded radially sheared axial flow.

In some embodiments, the method further includes providing the first plasma precursor is a first precursor gas (e.g., a neutral or partially ionized gas or gas mixture), and the second plasma precursor is a second precursor gas (e.g., a neutral or partially ionized gas or gas mixture).

In some embodiments, the method further includes providing the first plasma precursor is a first precursor plasma (e.g., a low-temperature plasma), and the second plasma precursor is a second precursor plasma (e.g., a low-temperature plasma).

In some embodiments, the first plasma precursor and the second plasma precursor include deuterium, tritium, hydrogen, helium, or any combination thereof.

In some embodiments, the method further includes, injecting a beam of neutral particles into the plasma chamber to beat and stabilize the first Z-pinch plasma, in the first operation mode, and the second Z-pinch plasma, in the second operation mode.

In accordance with another aspect, there is provided a plasma generation system including:
a plasma generator including a plasma chamber, the plasma generator being configured to generate a Z-pinch plasma in the plasma chamber; and
a neutral beam injection system coupled to the plasma generator, the neutral beam injection system being configured to inject a beam of neutral particles in the plasma chamber to enter into and heat the Z-pinch plasma.

In accordance with another aspect, there is provided a plasma generation system including:
a plasma confinement device including:
   a first electrode; and
   a second electrode arranged with respect to the first electrode to define therebetween a plasma chamber configured to receive a plasma precursor;
a power supply configured to apply a voltage between the first electrode and the second electrode to convert the plasma precursor into a Z-pinch plasma in the plasma chamber; and
a neutral beam injection system coupled to the plasma confinement device and configured to inject a beam of neutral particles in the plasma chamber and into the Z-pinch plasma.

In some embodiments, the first electrode is an inner electrode, and the second electrode is an outer electrode surrounding the inner electrode and projecting axially beyond the inner electrode, wherein the Z-pinch plasma is configured to flow axially in a region of the plasma chamber extending between a front end of the inner electrode and a front end of the outer electrode.

In some embodiments, the neutral beam injection system is configured to inject the beam of neutral particles in the plasma chamber via an injection port formed in the inner electrode, or via an injection port formed in the outer electrode, or via both an injection port formed in the inner electrode and an injection port formed in the outer electrode.

In some embodiments, an injection angle between an injection direction, along which the beam of neutral particles is injected in the plasma chamber, and a pinch axis, along which the Z-pinch plasma is flowing, is equal to zero. In other embodiments, the injection angle is different from zero.

In some embodiments, the neutral beam injection system is configured to inject a plurality of beams of neutral particles from a plurality of injection ports provided at different locations with respect to the plasma chamber.

In some embodiments, the plasma precursor may include a neutral gas or gas mixture. In other embodiments, the plasma precursor may include a partially (e.g., weakly) ionized gas or gas mixture, or a plasma (e.g., a low-temperature plasma).

In some embodiments, the beam of neutral particles may include isotopes of hydrogen, for example, deuterium or a mixture of deuterium and tritium.

In some embodiments, the Z-pinch plasma has an embedded radially sheared axial flow.

In accordance with another aspect, there is provided a plasma generation system including:
a plasma confinement device including:
   an inner electrode; and
   an outer electrode surrounding the inner electrode to define therebetween an acceleration region configured to contain an initial plasma, the outer electrode projecting axially beyond the inner electrode to define an assembly region adjacent the acceleration region, the assembly region extending between a front end of the inner electrode and a front end of the outer electrode;
a power supply configured to apply a voltage between the inner electrode and the outer electrode to cause the initial plasma to (i) flow along the acceleration region and into the assembly region and (ii) be compressed into a Z-pinch plasma that flows axially in the assembly region between the front end of the inner electrode and the front end of the outer electrode; and
a neutral beam injection system coupled to the plasma confinement device and configured to inject a beam of neutral particles in the assembly region to be coupled into and heat the Z-pinch plasma.

In accordance with another aspect, there is provided a plasma generation method including:
forming a Z-pinch plasma in a plasma chamber; and
injecting a beam of neutral particles in the plasma chamber to enter into and heat the Z-pinch plasma.

In some embodiments, forming the Z-pinch plasma in the plasma chamber includes:
introducing a plasma precursor in the plasma chamber; and
applying a voltage across the plasma chamber to energize and compress the plasma precursor into the Z-pinch plasma.

In accordance with another aspect, there is provided a plasma generation method including:
forming or introducing an initial plasma in an acceleration region defined between an inner electrode and an outer electrode of a plasma confinement device, the outer electrode projecting axially beyond the inner electrode to define an assembly region adjacent the acceleration region, the assembly region extending between a front end of the inner electrode and a front end of the outer electrode;
applying a voltage between the inner electrode and the outer electrode to cause the initial plasma to (i) flow along the acceleration region and into the assembly region and (ii) be compressed into a Z-pinch plasma flowing along the longitudinal axis in the assembly region; and
   injecting, with a neutral beam injection system coupled to the plasma confinement device, a beam of neutral particles in the assembly region to be coupled into and heat the Z-pinch plasma.

The dual-mode Z-pinch-based plasma generation system and method described herein can provide a number of advantages and benefits. Non-limiting examples include a variety and versatility of uses and applications brought about by the provision of two operating modes having different Z-pinch configurations, parameters, and formation processes, where switching between the two operating modes can be achieved by selective insertion or removal of an electrically insulating insert into or from a plasma chamber of the system in order to an available discharge volume of the plasma chamber.

Other method and process steps may be performed prior, during, or after the steps described herein. The order of one or more steps may also differ, and some of the steps may be omitted, repeated, and/or combined, as the case may be.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIGS. 1 to 5 are schematic representations of a conventional Z-pinch plasma generation system at five different stages of the Z-pinch formation.

FIG. 6 is a flow diagram of a method of controlling a plasma generation system having a first operation mode and a second operation mode, in accordance with an embodiment.

FIG. 7 is a schematic longitudinal cross-sectional view of an embodiment of a dual-mode plasma generation system, depicted in a first operation mode.

FIG. 8 is a schematic longitudinal cross-sectional view of the plasma generation system of FIG. 7, depicted in a second operation mode.

FIG. 9 is a schematic longitudinal cross-sectional view of another embodiment of a dual-mode plasma generation system, depicted in a second operation mode.

FIG. 10 is a schematic longitudinal cross-sectional view of another embodiment of a dual-mode plasma generation system, depicted in a second operation mode.

FIG. 11 is a schematic longitudinal cross-sectional view of another embodiment of a dual-mode plasma generation system, depicted in a second operation mode.

FIG. 12 is a schematic longitudinal cross-sectional view of another embodiment of a dual-mode plasma generation system, depicted in a second operation mode.

FIG. 13 is a schematic longitudinal cross-sectional view of another embodiment of a dual-mode plasma generation system, depicted in a second operation mode.

FIG. 14 is a schematic longitudinal cross-sectional view of another embodiment of a dual-mode plasma generation system, depicted in a first operation mode.

FIG. 15 is a schematic longitudinal cross-sectional view of the plasma generation system of FIG. 14, depicted in a second operation mode.

FIG. 16 is a schematic longitudinal cross-sectional view of another embodiment of a dual-mode plasma generation system, depicted in a first operation mode.

FIG. 17 is a schematic longitudinal cross-sectional view of the plasma generation system of FIG. 16, depicted in a second operation mode.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

The expressions “at least one of X, Y, and Z” and “one or more of X, Y, and Z”, and variants thereof, are understood to include X alone, Y alone, Z alone, any combination of X and Y, any combination of X and Z, any combination of Y and Z, and any combination of X, Y, and Z.

Ordinal terms such as “first”, “second”, “third”, and the like, to modify an element does not by itself connote any order, rank, priority, or precedence of one element over another, but are used merely to distinguish one element having a certain name from another element having otherwise the same name.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of ±10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “depending on”, “representative of”, “indicative of”, “associated with”, “relating to”, and the like.

The terms “match”, “matching”, and “matched” refer herein to a condition in which two elements are either the same or within some predetermined tolerance of each other. That is, these terms are meant to encompass not only “exactly” or “identically” matching the two elements, but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, fluidic, logical, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

The present description discloses a Z-pinch-based plasma generation system and a related method of operation, where the system includes two operation modes characterized by different Z-pinch configurations and formation processes. Switching between the two operation modes can be achieved by selective insertion or removal of an electrically insulating insert into or from a plasma chamber of the system to vary an available discharge volume of the plasma chamber.

The present techniques can find use in various fields and applications including, to name a few, fusion power generation, plasma sources, ions sources, plasma accelerators, neutron and high-energy photon generation, materials processing, linear Z-pinches, sheared-flow-stabilized Z-pinches, fusion-based medical devices (e.g., boron neutron capture therapy, electron therapy, proton therapy), and plasma focus devices.

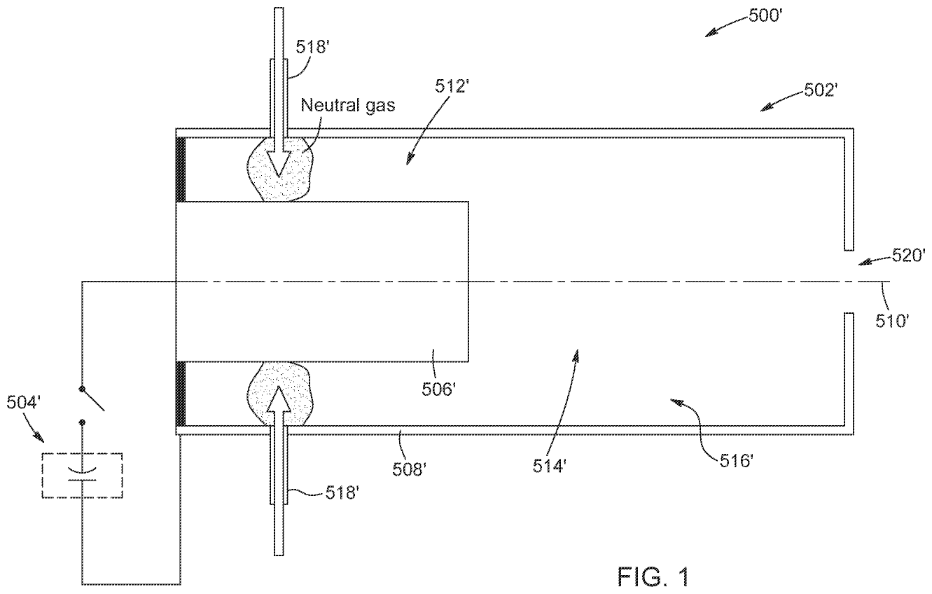

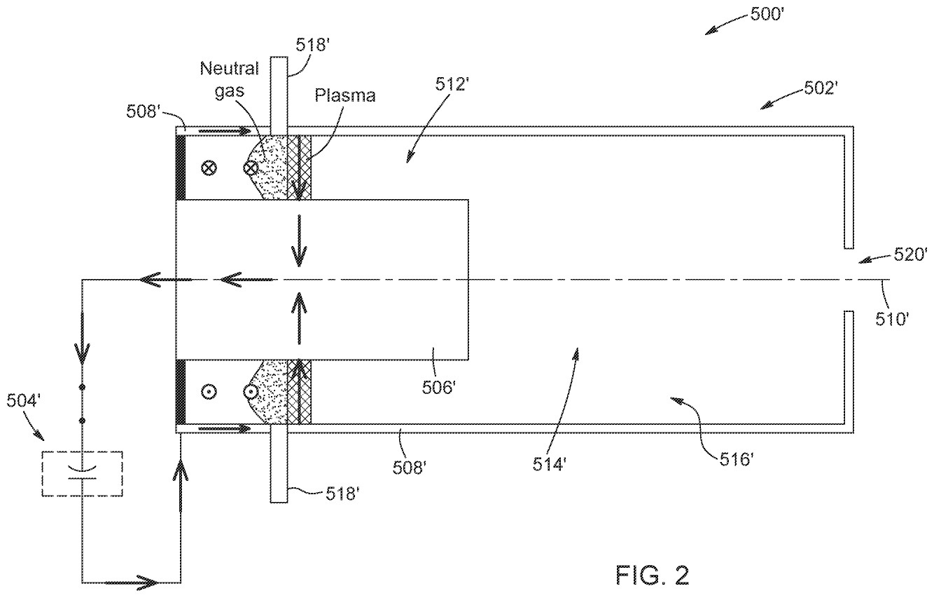

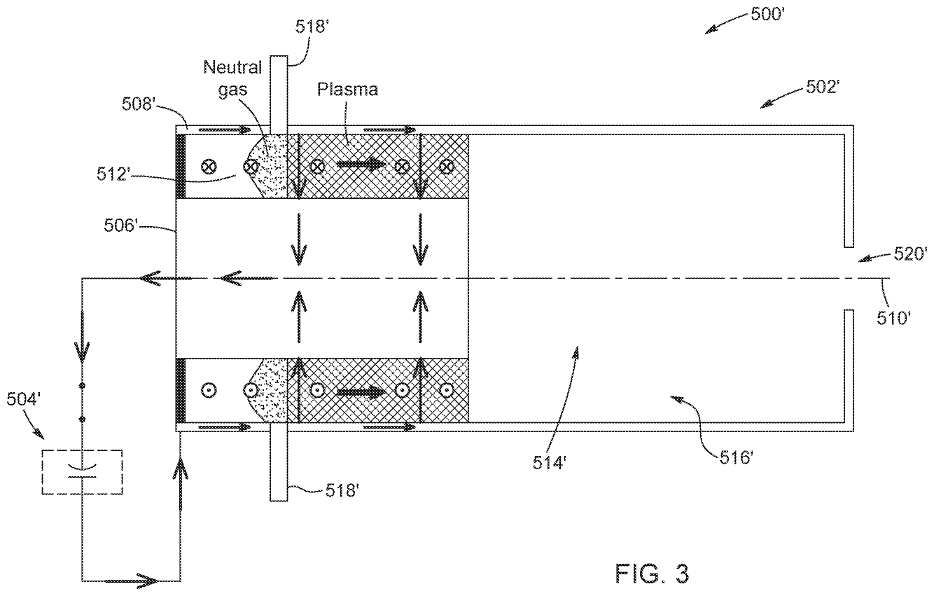

Magnetic plasma confinement is one of several approaches to achieving controlled fusion for power generation. Different types of configurations for magnetic plasma confinement have been devised and studied over the years, among which is the Z-pinch configuration. Referring to FIGS. 1 to 5, there are provided schematic representations of a conventional Z-pinch plasma generation system 500′ at different stages of the Z-pinch formation. The plasma generation system 500′ includes a plasma confinement device 502′ and a power supply unit 504′ configured to supply power to the plasma confinement device 502′. The plasma confinement device 502′ includes an inner electrode 506′ and an outer electrode 508′. The inner electrode 506′ and the outer electrode 508′ form a coaxial electrode arrangement extending along a longitudinal Z-pinch axis 510′. In the illustrated configuration, the outer electrode 508′ extends longitudinally beyond the inner electrode 506′. The annular volume extending between the inner electrode 506′ and the outer electrode 508′ defines a plasma acceleration region 512′, while the cylindrical volume surrounded by the outer electrode 508′ and extending beyond the inner electrode 506′ defines a Z-pinch assembly region 514′. The plasma acceleration region 512′ and the Z-pinch assembly region 514′ define a reaction chamber 516′ of the plasma confinement device 502′. The formation of a Z-pinch plasma can include injecting neutral gas in the acceleration region 512′ (FIG. 1), and applying, using the power supply unit 504′, a voltage between the inner electrode 506′ and the outer electrode 508′ (FIG. 2). The neutral gas can be injected into the acceleration region 512′ via one or more gas injection ports 518 of the plasma confinement device 502″ (e.g., formed through the peripheral surface of the outer electrode 508′), the one or more gas injection ports 518′ being connected to a gas supply system including a neutral gas source (not shown). The power supply unit 504′ can include a high-voltage capacitor bank and a switch. The voltage applied between the inner electrode 506′ and the outer electrode 508′ is configured to ionize the neutral gas, resulting in the formation of an annular column or washer of plasma in the acceleration region 512′. The plasma column allows electric current to flow radially therethrough between the inner and outer electrodes 506′, 508′ (FIG. 2). The electric current that flows axially along the inner electrode 506′ generates an azimuthal magnetic field in the acceleration region 512 (FIG. 3).

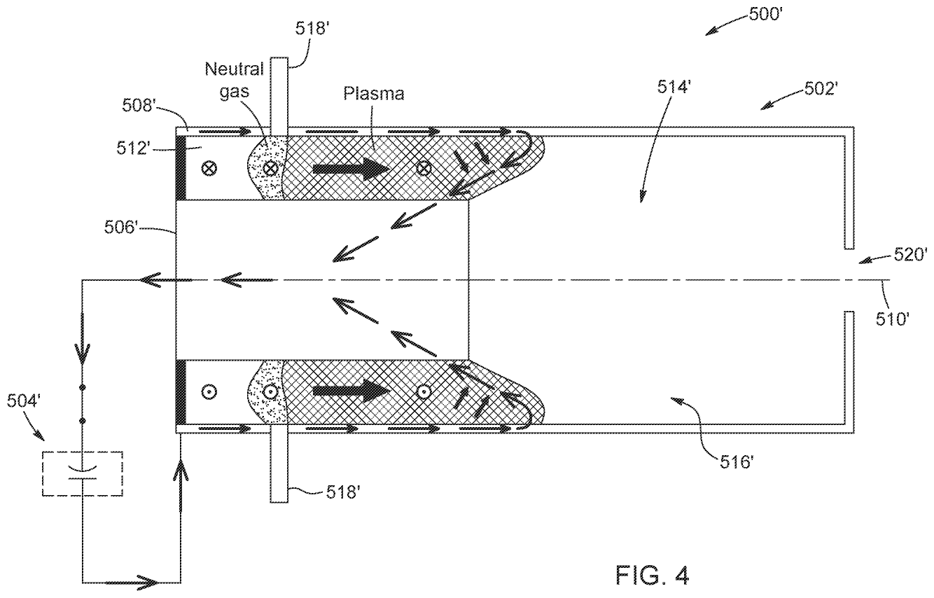

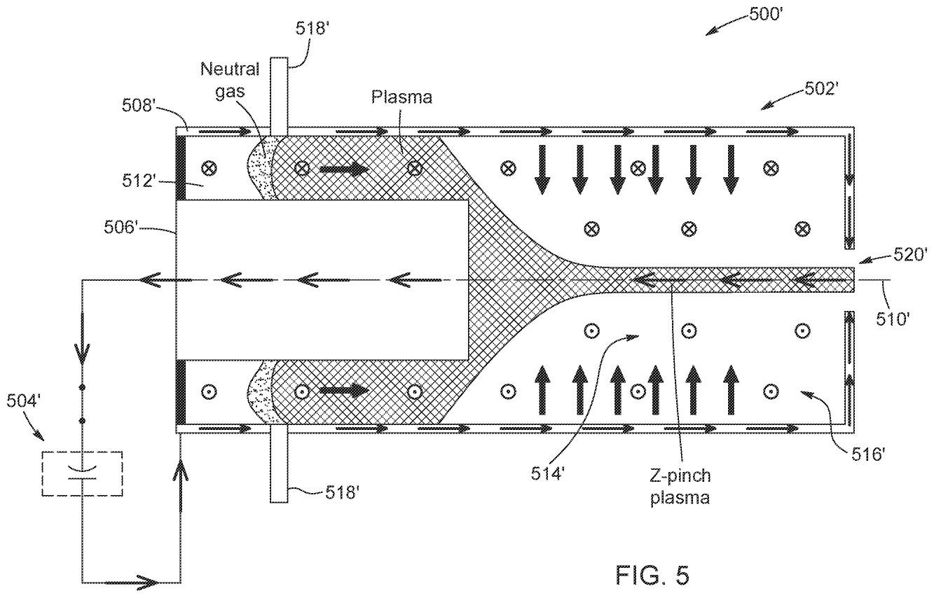

The interaction between the radial electric current flowing in the plasma column and the azimuthal magnetic field produces a Lorentz force in the axial direction that pushes and accelerates the plasma column axially forward along the acceleration region 512′ (FIG. 3) until the plasma column reaches the entrance of the assembly region 514′ and the Z-pinch formation begins (FIG. 4). In the assembly region 514′, the direction of the Lorentz force changes from longitudinal to radially inward, which makes the plasma column collapse inwardly toward the Z-pinch axis 510′ to complete the formation of a Z-pinch plasma (FIG. 5). The axial current flowing in the Z-pinch plasma generates an azimuthal magnetic field that exerts an inward magnetic pressure and an inward magnetic tension, which radially compress the Z-pinch plasma against the outward plasma pressure until an equilibrium is established. In this configuration, the Z-pinch plasma can continue to form and move along the assembly region 514′ for as long as neutral gas is supplied and ionized in the acceleration region 512′. In FIGS. 1 to 5, the plasma confinement device 502′ includes a plasma exit port 520′ configured to allow part of the Z-pinch plasma to exit the plasma confinement device 502′, so as to avoid a stagnation point in the plasma flow that could create instabilities.

By increasing the axial current to compress the Z-pinch plasma to sufficiently high density and temperature, fusion reactions can be achieved within the pinch, resulting in an exothermic energy release. In many applications, fusion reactions release their energy in the form of neutrons. A commonly used fusion reaction is the deuterium-tritium reaction, or D-T reaction, in which the fusion of one deuterium nucleus and one tritium nucleus produces one alpha particle and one neutron. Being chargeless, neutrons can escape from the magnetically confined plasma pinch and transfer their kinetic energy into thermal energy after they exit the confinement region. This thermal energy can be converted into electricity, for example, by transferring the heat generated to a working fluid used by a heat engine for generating electrical energy. The remaining fusion products have kinetic energy that can contribute more energy to the fusion process.

Conventional Z-pinch configurations are unstable due to the presence of magnetohydrodynamic (MHD) instabilities. A challenge in Z-pinch fusion research is devising ways of improving the control over instabilities to keep Z-pinch plasmas confined long enough to sustain ongoing fusion reactions. Techniques such as close-fitting walls, externally applied axial magnetic fields, and pressure profile control have been proposed, with mitigated results. Recent advances have demonstrated that sheared plasma flows—that is, plasma flows with a radius-dependent axial velocity—can provide a promising stabilization approach to achieving and sustaining fusion conditions in Z-pinch configurations. For example, the velocity at the center of the Z-pinch plasma may range from about 20 km/s to about 150 km/s, while the velocity at the edge of the Z-pinch plasma may range from about 80 km/s to 150 km/s or may be as low as −20 km/s to 20 km/s. One of the keys to unlocking the potential of sheared-flow-stabilized Z-pinch fusion devices as these devices are scaled up in power input—and thus in power output—is to mitigate, circumvent, or otherwise control instabilities, turbulence, heat transfer, and other factors limiting plasma lifetime. This is because once the reaction becomes unstable, the pinch ceases, neutron production stops, and power generation shuts down. Researchers have theorized that fusion conditions resulting in viable net power output that can be met at high power input are achievable when the flow shear exceeds a certain threshold above which the Z-pinch is stable, this threshold depending on the magnetic field strength and the plasma density. It is appreciated that the theory, instrumentation, implementation, and operation of conventional sheared-flow-stabilized Z-pinch plasma confinement devices are generally known in the art and need not be described in detail herein other than to facilitate an understanding of the present techniques. Reference is made in this regard to International Patent Application PCT/US2018/019364 (published as WO 2018/156860) as well as the following doctoral dissertation: Golingo, Raymond, Formation of a Sheared Flow Z-Pinch (University of Washington, 2003). The contents of these two documents are incorporated herein by reference in their entirety.

As noted above, the present techniques relate to dual-mode Z-pinch-based plasma generation systems and methods, in which the two operation modes are characterized by different Z-pinch parameters and properties. Switching between the two operation modes can be achieved by controlling an available discharge volume for the Z-pinch formation process, which in turn can be achieved by selective insertion or removal of an electrically insulating insert into or from the plasma chamber. It is appreciated that the present techniques are not limited for use in sheared-flow-stabilized Z-pinch fusion reactors and can be implemented in a wide range of Z-pinch-based plasma applications.

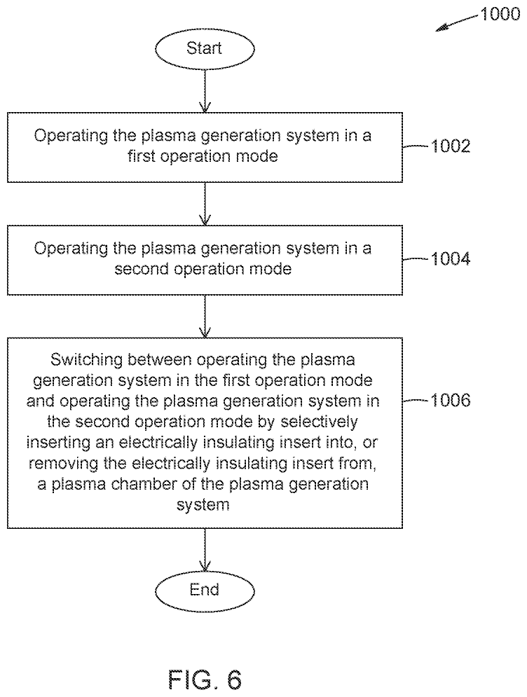

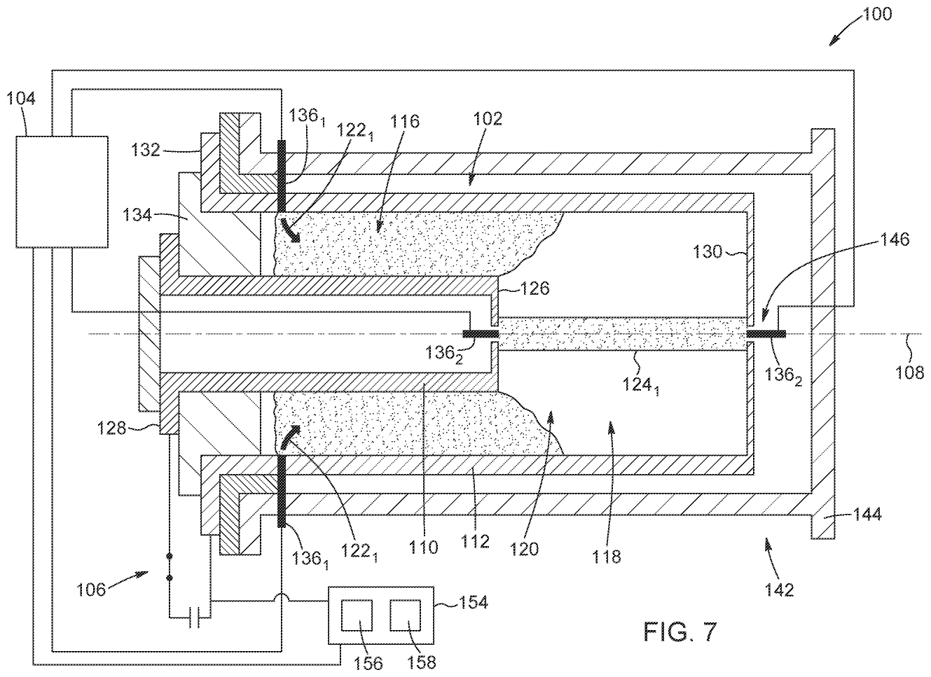

Referring to FIG. 6, there is illustrated a flow diagram of an embodiment of a method 1000 of controlling a plasma generation system having a first operation mode and a second operation mode. The method 1000 of FIG. 6 may be implemented in a plasma generation system 100 such as the ones depicted in FIGS. 7 to 17, or another suitable plasma generation system. The plasma generation system can include a plasma confinement device extending a longitudinal axis. The plasma confinement device can include an inner electrode and an outer electrode surrounding the inner electrode to define an acceleration region therebetween. The outer electrode extends beyond the inner electrode along the longitudinal axis to define an assembly region adjacent the acceleration region. The acceleration region and the assembly region together define a plasma chamber. The plasma confinement device also includes an electrically insulating insert configured for removable insertion in the plasma chamber. The plasma generation system also includes a precursor supply unit coupled to the plasma chamber, and a power supply unit coupled to the inner electrode and the outer electrode.

Broadly described, the method 1000 can include a step 1002 of operating the plasma generation system in the first operation mode, a step 1004 of operating the plasma generation system in the second operation mode, and a step 1006 of switching between operating the plasma generation system in the first operation mode and operating the plasma generation system in the second operation mode. In the step 1002 of operating the plasma generation system in the first operation mode, the electrically insulating insert is removed from the plasma chamber, whereas in the step 1004 of operating the plasma generation system in the second operation mode, the electrically insulating insert is inserted into the plasma chamber and arranged with respect to the inner electrode and the outer electrode to reduce an available discharge volume of the plasma chamber to substantially exclude the acceleration region. The first operation mode can include a step of supplying, with the precursor supply unit, a first plasma precursor in the acceleration region, and a step of energizing, with the power supply unit, the first plasma precursor supplied in the acceleration region to cause a plasma flow to move along the acceleration region and into the assembly region and to be compressed into a first Z-pinch plasma extending along the longitudinal axis in the assembly region. The second operation mode can include a step of supplying, with the precursor supply unit, a second plasma precursor in the assembly region, within the available discharge volume of the plasma chamber, and a step of energizing, with the power supply unit, the second plasma precursor supplied in the assembly region into a second Z-pinch plasma extending along the longitudinal axis in the assembly region. The step 1006 of switching between the first and second operation modes can be achieved by selectively inserting the electrically insulating insert into or removing the electrically insulating insert from the plasma chamber.

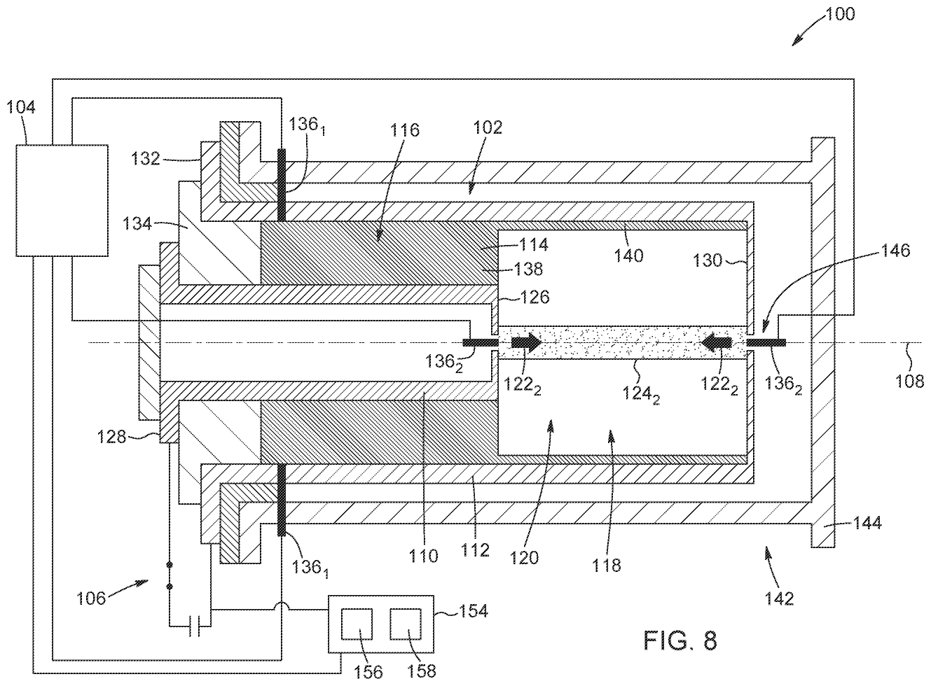

Referring to FIGS. 7 and 8, there are illustrated schematic longitudinal cross-sectional views of a plasma generation system 100, in accordance with an embodiment, where FIG. 7 depicts the system 100 in a first operation mode and FIG. 8 depicts the system 100 in a second operation mode. The plasma generation system 100 generally includes a plasma confinement device 102, a precursor supply unit 104, and a power supply unit 106. The plasma confinement device 102 extends along a longitudinal axis 108, which can also be referred to as a “Z-pinch axis”. As used herein, the terms “longitudinal” and “axial” generally refer to a direction parallel to the longitudinal axis 108, while the terms “radial” and “transverse” generally refer to a direction that lies in a plane perpendicular to the longitudinal axis 108. Depending on the application, the plasma generation system 100 may be operated with the longitudinal axis 108 of the plasma confinement device 102 parallel, perpendicular, or at an oblique angle relative to the local gravitational field.

The plasma confinement device 102 includes an inner electrode 110, an outer electrode 112, and a removable electrically insulating insert 114. The outer electrode 112 surrounds the inner electrode 110 to define an acceleration region 116 therebetween. The outer electrode 112 extends forwardly beyond the inner electrode 110 along the longitudinal axis 108 to define an assembly region 118 adjacent the acceleration region 116. The volume occupied by the acceleration region 116 and the assembly region 118 defines a plasma chamber 120 of the plasma confinement device 102. The removable insert 114 is configured for removable insertion in the plasma chamber 120 to allow the plasma generation system 100 to be operated in either the first operation mode (FIG. 7; no insert 114 inside plasma chamber 120) or the second operation mode (FIG. 8; insert 114 inserted inside plasma chamber 120).

In both operation modes, the precursor supply unit 104 is coupled to the interior of the plasma chamber 120, for example, via one or more precursor supply ports formed through either or both of the inner electrode 110 and the outer electrode 112. The precursor supply unit 104 is configured to supply a plasma precursor 122₁, 122₂ to the plasma chamber 120 for the plasma precursor 122₁, 122₂ to be energized into a Z-pinch plasma 124₁, 124₂. The term “Z-pinch plasma” broadly refers herein to a plasma that has an electric current flowing substantially along the longitudinal or axial direction Z of a cylindrical coordinate system (e.g., the longitudinal axis 108 in FIGS. 7 and 8). The axial electrical current generates an azimuthal magnetic field that radially compresses, or pinches, the plasma by the Lorentz force. It is appreciated that, in some instances, terms such as “Z-pinch”, “zeta pinch”, “plasma pinch”, “pinch”, “plasma arc” may be used interchangeably with the term “Z-pinch plasma”. Depending on the application, the plasma precursor 122₁, 122₂ supplied to the plasma chamber 120 by the precursor supply unit 104 can be a neutral gas or gas mixture, a partially (e.g., weakly) ionized gas or gas mixture, a plasma (e.g., a low-energy plasma formed by the precursor supply unit 104 outside the plasma chamber 120), or any combination thereof.

In both operation modes, the power supply unit 106 is configured to apply a discharge driving signal (e.g., a discharge voltage) to the inner electrode 110 and the outer electrode 112 to energize the plasma precursor 122₁, 122₂ into the Z-pinch plasma 124₁, 124₂ flowing longitudinally in the assembly region 118. In some embodiments, the Z-pinch plasma 124₁, 124₂ in either operation mode may have the following properties and parameters: a plasma radius ranging from about 0.1 mm to about 5 mm, a magnetic field ranging from about 0.1 T to about 20 T, an electron temperature ranging from about 100 eV to about 20 keV, an ion temperature ranging from about 100 eV to about 20 keV, an electron density ranging from about 10¹⁷ cm⁻³ to about 10²⁰ cm⁻³, an ion density ranging from about 10¹⁷ cm⁻³ to about 10²⁰ cm⁻³, and a stable lifetime exceeding 10 μs (e.g., up to 1 ms). These values are provided by way of example, so that other Z-pinch property and parameter values may be used in other embodiments. In some embodiments, a radially sheared axial flow can be embedded in the Z-pinch plasma 124₁, 124₂. However, in other embodiments, the Z-pinch plasma 124₁, 124₂ may be generated without a radial velocity shear (e.g., as a linear Z-pinch with a purely axial flow).

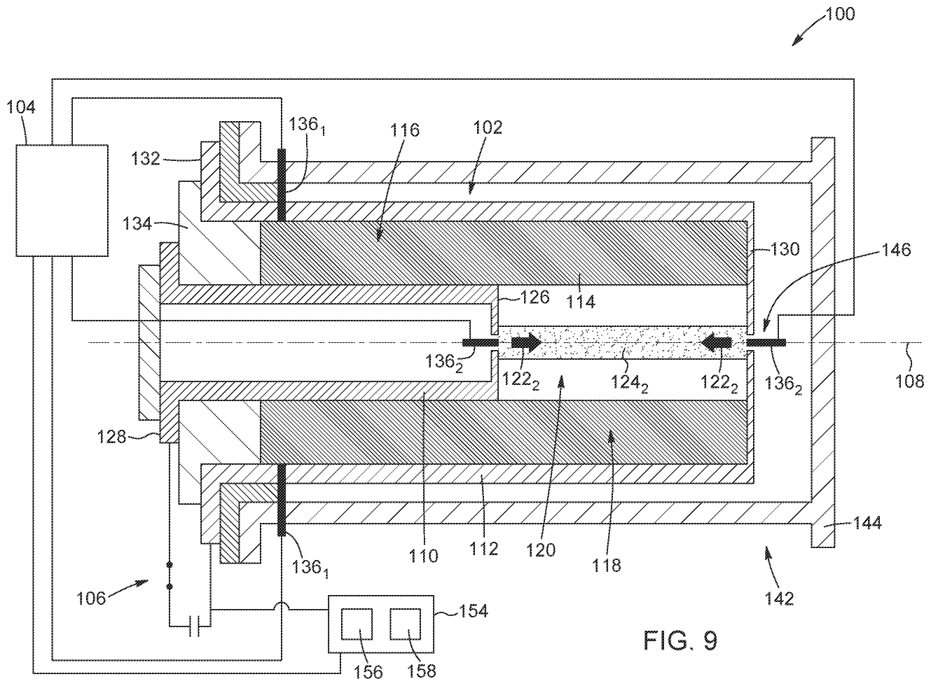

More details regarding the structure, configuration, and operation of these components and other possible components of the plasma generation system 100 will be given below. It is appreciated that FIGS. 7 and 8 are simplified schematic representations that illustrate certain features and components of the plasma generation system 100, such that additional features and components that may be useful or necessary for its practical operation may not be specifically depicted, and likewise for FIGS. 9 to 17 described below. Non-limiting examples of such additional features and components can include, to name a few, power supplies, electrical connections, gas sources, gas supply lines (e.g., conduits, such as pipes or tubes), pressure and flow control devices (e.g., pumps, valves, regulators, restrictors), temperature control devices, operation monitoring and diagnostic devices (e.g., sensors), processors and controllers, and other types of hardware and equipment. It is noted that in the present description, the subscript 1 generally refers to the first operation mode and the subscript 2 generally refers to the second operation mode.

Referring now more specifically to FIG. 7, the structure, configuration, and operation of the plasma generation system 100 in the first operation mode will be described in greater detail. It is appreciated that the electrically insulating insert 114, which is used in the second operation mode illustrated in FIG. 7, is removed from the plasma chamber 120 and need not be used in the first operation mode.

The inner electrode 110 and the outer electrode 112 both have an elongated configuration along the longitudinal axis 108 of the plasma confinement device 102. The inner electrode 110 has a front end 126 and a rear end 128, and the outer electrode 112 has a front end 130 and a rear end 132. In the illustrated arrangement, the inner electrode 110 and the outer electrode 112 both have a substantially cylindrical configuration with a circular cross-section transverse to the longitudinal axis 108. Depending on the application, the inner electrode 110 may have a full or hollow configuration. In the illustrated embodiment, the outer electrode 112 coaxially encloses the inner electrode 110. However, various other electrode configurations can be used in other embodiments. Non-limiting examples include, to name a few, non-coaxial arrangements, non-circularly symmetric transverse cross-sections, three-electrode arrangements, and the like.

The inner electrode 110 and the outer electrode 112 may each be made of any suitable electrically conductive material, such as various metals and metal alloys. Non-limiting examples include, to name a few, tungsten-coated copper and graphite. In some embodiments, the inner electrode 110 may have a length ranging from about 25 cm to about 10 meters and a radius ranging from about 2 cm to about 1 m, while the outer electrode 112 may have a length ranging from about 50 cm to about 15 m, a radius ranging from about 6 cm to about 2 m or more, and a wall thickness ranging from about 6 mm to about 12 mm, although other electrode dimensions may be used in other embodiments. Depending on the application, the inner electrode 110 and the outer electrode 112 may be of varying sizes, shapes, compositions, and configurations.

In some embodiments, the plasma confinement device 102 can also include an electrode insulator 134 disposed between the inner electrode 110 and the outer electrode 112. The electrode insulator 134 is configured to provide electrical insulation between the inner electrode 110 and the outer electrode 112, so as to prevent or help prevent unwanted charge buildup and other undesirable electrical phenomena that could adversely affect the operation of the plasma confinement device 102. In the illustrated embodiment, the electrode insulator 134 has an annular cross-sectional shape and is disposed near the rear ends 128, 132 of the inner and outer electrodes 110, 112. The electrode insulator 134 may be made of any suitable electrically insulating material, for example, glass, ceramic, glass-ceramic, and polymer materials. More specific examples of possible materials include, to name a few, alumina, boron nitride, borosilicate glass, porcelain, quartz, polytetrafluoroethylene (PTFE), MACOR®, and Teflon®. Depending on the application, the electrode insulator 134 can be of varying sizes, shapes, compositions, locations, and configurations.

In the illustrated arrangement, the acceleration region 116 has a substantially annular cross-sectional shape defined by the cross-sectional shapes of the inner electrode 110 and the outer electrodes 112. In some embodiments, the acceleration region 116 may have a length ranging from about 25 cm to about 10 m and an annular thickness ranging from about 2 cm to about 50 cm, although other dimensions may be used in other embodiments. The acceleration region 116 is configured to receive a first plasma precursor 122₁ from the precursor supply unit 104 via one or more first precursor supply ports 136₁ formed through either or both of the inner electrode 110 and the outer electrode 112. In the embodiment of FIG. 7, the precursor supply unit 104 is depicted as including two first precursor supply ports 136₁ formed through a periphery of the outer electrode 112 at the same longitudinal position near the rear end 132 thereof but at opposite azimuthal positions. However, depending on the application, the one or more first precursor supply ports 136₁ may be formed only through a periphery of the inner electrode 110, only through a periphery of the outer electrode 112, or through both a periphery of the inner electrode 110 and a periphery of the outer electrode 112, or any suitable locations of the inner electrode 110 and/or the outer electrode 112. It is appreciated that the number of first precursor supply ports 136₁, as well as their longitudinal, azimuthal, and radial arrangements with respect to the acceleration region 116 can be varied to suit the needs or preferences of a particular application. Furthermore, different first precursor supply ports 136₁ may be configured to supply first plasma precursors 122₁ of different types and/or having different properties and parameters.

The assembly region 118 has a substantially circular cross-sectional shape defined by the cross-sectional shape of the portion of the outer electrode 112 that projects beyond the front end 126 of the inner electrode 110. The assembly region 118 extends from the front end 126 of the inner electrode 110 to the front end 130 of the outer electrode 112. In the illustrated embodiment, the front end 126 of the inner electrode 110 is flat, and the front end 130 of the outer electrode 112 defines a front endwall of the plasma confinement device 102. However, non-flat geometries (e.g., half-spherical, conical, tapered, either concave or convex) for the front ends 126, 130 of either or both of the inner and outer electrodes 110, 112 are possible in other embodiments. The assembly region 118 is configured to sustain a first Z-pinch plasma 124₁ along the longitudinal axis 108 between the front end 126 of the inner electrode 110 and the front end 130 of the outer electrode 112. In some embodiments, the assembly region 118 may have a length ranging from about 25 cm to about 5 m, although other dimensions may be used in other embodiments.

In some embodiments, the plasma confinement device 102 may include a plasma exit port 146 configured to allow part of the Z-pinch plasma 124₁, 124₂ to exit the plasma confinement device 102, for example, to avoid a stagnation point in the plasma flow that could create instabilities in the Z-pinch plasma 124₁, 124₂. In the illustrated embodiment, the plasma exit port 146 is provided as an opening formed on the longitudinal axis 108 at the front end 130 of the outer electrode 112. In other embodiments, the plasma exit port 146 may be provided at other locations of the plasma confinement device 102, for example,

through the peripheral wall of the outer electrode 112. In yet other embodiments, a plurality of plasma exit ports may be provided.

The power supply unit 106 is coupled to the inner electrode 110 and the outer electrode 112 via appropriate electrical connections. The term “power supply unit” refers herein to any device or combination of devices configured to supply electrical power into a form usable by another device or combination of devices. It is appreciated that while the power supply unit 106 depicted in FIG. 7 as a single entity for illustrative purposes, the term “power supply unit” should not be construed as being limited to a single power supply and, accordingly, in some embodiments the power supply unit 106 may include a plurality of power supplies.

The power supply unit 106 may include a high-power pulsed-DC source (e.g., a capacitor bank, a Marx generator, or a linear transformer driver), a switch (e.g., a spark gap, an ignitron, or a semiconductor switch), and a pulse shaping network (including, e.g., inductors, resistors, ignitrons, diodes, and the like). Other suitable types of power supplies may be used in other embodiments, including DC power supplies, such as DC grids, voltage source converters, and homopolar generators. Depending on the application, the power supply unit 106 may be voltage-controlled or current-controlled. It is appreciated that the instrumentation implementation, and operation of power supplies used in plasma generation systems are generally known in the art and need not be described in greater detail herein.

The power supply unit 106 is configured to supply power to apply a discharge driving signal to the inner electrode 110 and the outer electrode 112 to generate an accelerating electric field across the acceleration region 116. The accelerating electric field is configured to energize the first plasma precursor 122₁ to cause a plasma flow to move along the acceleration region 116 and into the assembly region 118, where the plasma flow can be compressed into the first Z-pinch plasma 124₁ onto the longitudinal axis 108. In some embodiments, the discharge driving signal can be a voltage pulse having a peak magnitude ranging from about 1 kV to about 100 kV, although other peak magnitude voltage values, may be used in other embodiments. The operation of the power supply unit 106 may be selected in view of the nature and parameters of the first plasma precursor 122₁ injected inside the acceleration region 116, and the configuration and operating conditions of the plasma confinement device 102 in order to favor the acceleration (and possibly the ionization) of the first plasma precursor 122₁ along the acceleration region 116 and its compression into the first Z-pinch plasma 124₁ in the assembly region 118

In some embodiments, the operation of applying the discharge driving signal by the power supply unit 106 can be initiated after initiating the operation of supplying the first plasma precursor 122₁ into the acceleration region 116 by the precursor supply unit 104. For example, in some embodiments, the operation of applying the discharge driving signal can be initiated with a time delay ranging from about 1 ns to about 20 ms after the operation of supplying the first plasma precursor 122₁ into the acceleration region 116. However, in other embodiments, the operation of applying the discharge driving signal can be initiated before or at the same time as initiating the process supplying the first plasma precursor 122₁ into the acceleration region 116.

In some embodiments, the precursor supply unit 104 may be configured to supply the first plasma precursor 122₁ as a neutral or partially (e.g., weakly) ionized gas or gas mixture. In such embodiments, the formation of the first Z-pinch plasma 124₁ can proceed similarly to as described above with respect to FIGS. 1 to 5. That is, upon applying a discharge driving signal (e.g., a discharge voltage) to the inner and outer electrodes 110, 112 by the power supply unit 106, an electrical field is created in the acceleration region 116 that ionizes and energizes the precursor gas 122₁ into an annular plasma column. The plasma column allows electric current to flow radially therethrough between the inner electrode 110 and the outer electrode 112. The electric current that flows axially along the inner electrode 110 and the outer electrode 112 generates an azimuthal magnetic field in the acceleration region 116. The interaction between the radial electric current flowing in the plasma column and the azimuthal magnetic field produces a Lorentz force in the axial direction that causes the plasma column to propagate and be accelerated axially forward along the acceleration region 116 until the plasma column reaches the entrance of the assembly region 118 and the first Z-pinch plasma 124₁ begins to form. In the assembly region 118, the direction of the Lorentz force changes from longitudinal to radially inward, which makes the plasma column collapse inwardly toward the longitudinal axis to complete the formation of the first Z-pinch plasma 124₁. The axial current flowing in the first Z-pinch plasma 124₁ generates an azimuthal magnetic field. This magnetic field produces an inward magnetic pressure that radially compresses the first Z-pinch plasma 124₁ against the outward plasma pressure until an equilibrium is established. In this configuration, the first Z-inch plasma 124₁ can continue to form and move along the assembly region 118 for as long as the precursor gas 122₁ gas is supplied and ionized in the acceleration region 116.

In other embodiments, the precursor supply unit 104 may be configured to supply the first plasma precursor 122₁ as an already-formed plasma. For example, the precursor supply unit 104 may be configured to form a first precursor plasma 122₁ outside the acceleration region 116 and inject the first precursor plasma 122₁ into the acceleration region 116 via the one or more first precursor supply ports 136₁. The first precursor plasma 122₁ thus injected can be accelerated along the acceleration region 116 and compressed into the first Z-pinch plasma 124₁ in the assembly region 118. In such embodiments, the first Z-pinch plasma 124₁ can be formed as a result of two independently controlled processes: (i) a plasma formation and injection process, and (ii) a plasma acceleration and compression process. Such embodiments can provide enhanced control over the Z-pinch parameters and properties (e.g., plasma density, temperature, velocity, magnetic field, lifetime, and the like). Non-limiting examples of plasma generation systems and methods that use such or similar plasma formation and injection techniques are disclosed in International Patent Application PCT/US2021/062830, filed Dec. 10, 2021, and published as WO 2022/125912 on Jun. 16, 2022, the contents of which are incorporated herein by reference in their entirety. It is appreciated that, in such embodiments, the precursor supply unit 104 may include various types of plasma sources and may be configured to implement various plasma formation and injection techniques to form the first precursor plasma 122₁ and inject the first precursor plasma 122₁ into the acceleration region 116. Non-limiting examples of suitable plasma sources are disclosed in U.S. Provisional Patent Application Ser. No. 63/352,251, filed Jun. 15, 2022, the contents of which are incorporated herein by reference in their entirety. Other examples of such possible plasma sources can include gas injected washer plasma guns, plasma thrusters (e.g., Hall effect thrusters and MHD thrusters), high-power helicon plasma sources, RF plasma sources; and laser-based plasma sources.

In some embodiments, first precursor plasma 122₁ may be a plasma having the following properties and parameters: an electron temperature ranging from about 1 eV to about 100 eV, an ion temperature ranging from about 1 eV to about 100 eV, an electron density ranging from about 10¹³ cm⁻³ to about 10¹⁶ cm⁻³, an ion density ranging from about 10¹³ cm⁻³, to about 10¹⁶ cm⁻³, and a degree of ionization ranging from about 50% to about 100% Depending on the application, the plasma may be magnetized or unmagnetized.

In yet other embodiments, the precursor supply unit 104 may be configured to supply the first plasma precursor 122₁ as a mixture of neutral or weakly ionized gas and plasma.

Depending on the application, the first Z-pinch plasma 124₁ may or may not be sheared-flow stabilized. In some embodiments, a radially sheared axial flow can be embedded in the first Z-pinch plasma 124₁ due to the velocity of the plasma flow as it exits the acceleration region 116 and enters the assembly region 118, where it is compressed into the first Z-pinch plasma 124₁. However, in other embodiments, the first Z-pinch plasma 124₁ may be generated without a radial velocity shear, as noted above

In some embodiments, the plasma generation system 100 may be configured to compress and heat the first Z-pinch plasma 124₁ sufficiently to reach fusion conditions, that is, plasma temperature and density conditions at which fusion reactions can occur inside the first Z-pinch plasma 124₁. In such embodiments, the output energy produced by the fusion reactions, which typically involve the generation of neutrons, exceeds the input energy required to establish fusion conditions. In fusion power applications, the output energy can be converted into electricity.

Referring now more specifically to FIG. 8, the structure, configuration, and operation of the plasma generation system 100 in the second operation mode will be described in greater detail. In the second operation mode, the electrically insulating insert 114 is inserted in the plasma chamber 120, that is, in the acceleration region 116 (and possibly also in the assembly region 118) to reduce the effective volume of the plasma chamber 120, resulting in a different Z-pinch formation process.

The removable insert 114 may be made of any suitable electrically insulating material. Non-limiting examples of such possible materials include glass, ceramic, glass-ceramic materials, polymer materials, or any combination thereof. More specific examples of possible materials include, to name a few, alumina, borosilicate glass, porcelain, polycarbonate, Rexolite®, and MACOR®. In some embodiments, the removable insert 114 may be made of a material having a high mechanical strength, a good machinability, and/or good thermal insulating properties. The removable insert 114 may be arranged with respect to the inner and outer electrodes 110, 112 such that upon the application of a discharge driving signal (e.g., a discharge voltage) to the inner and outer electrodes 110, 112, an available discharge volume of the plasma chamber 120 is reduced to substantially exclude the acceleration region 116. In other words, the removable insert 114 is configured to reduce the available discharge volume of the plasma chamber 120 to the assembly region 118, or to a portion of the assembly region 118.

It is appreciated that depending on the application, the removable insert 114 can have various sizes, shapes, locations, and configurations in order to provide the reduction in available discharge volume and allow for the plasma generation system 100 to be operated in the second operation mode. For example, in the embodiment of FIG. 8, the removable insert 114 is shaped as an annular cylinder having a first annular segment 138 and a second annular segment 140. Upon insertion of the removable insert 114 in the plasma chamber 120, the first annular segment 138 is configured to occupy an entirety of the acceleration region 116 and the second annular segment 140 is configured to occupy an outer portion of the assembly region 118. In FIG. 8, the inner radius of the first annular segment 138 is substantially equal to the outer radius of the inner electrode 110 and is smaller than the inner radius of the second annular segment 140. Meanwhile, the outer radius of the first annular segment 138 is substantially equal to the inner radius of the outer electrode 112 and to the outer radius of the second annular segment 140.

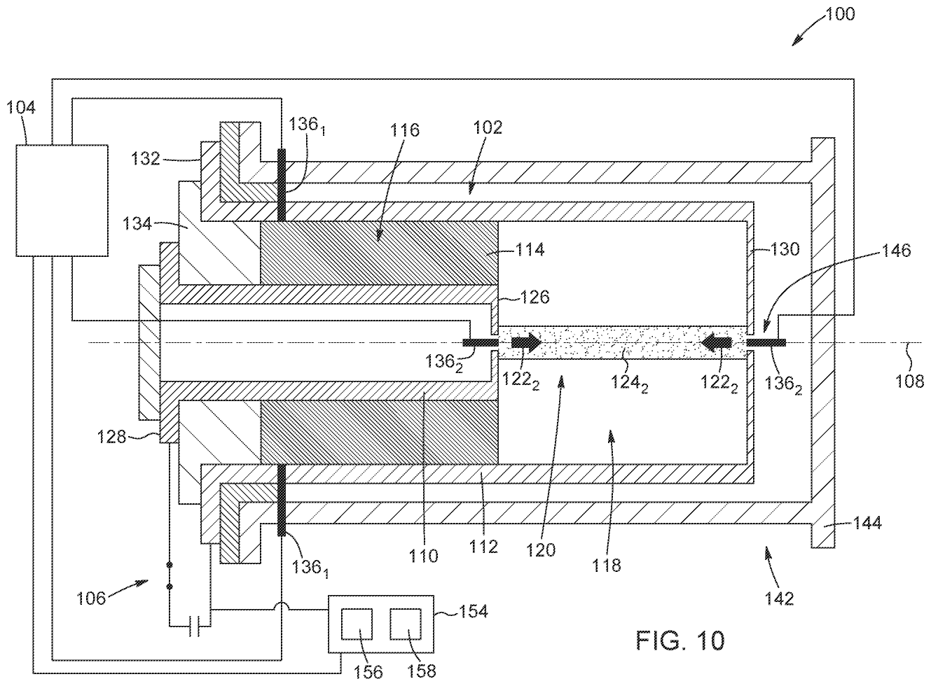

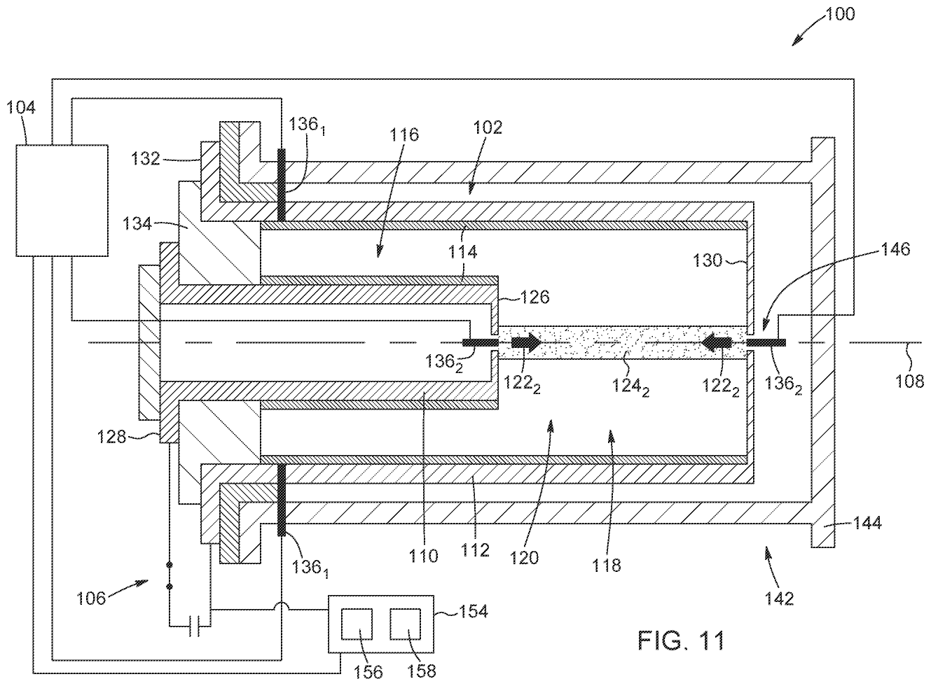

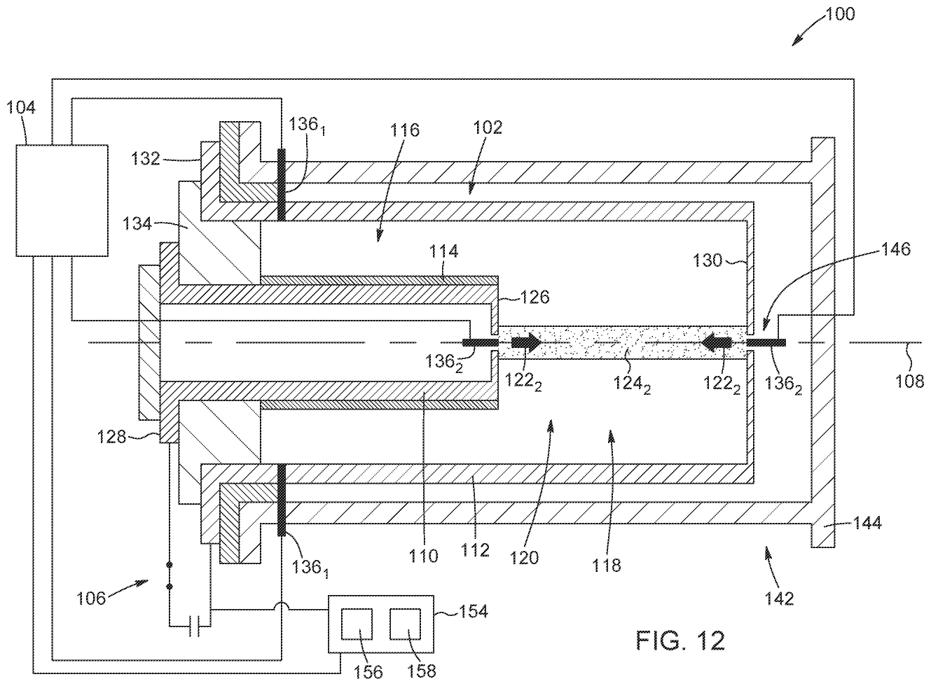

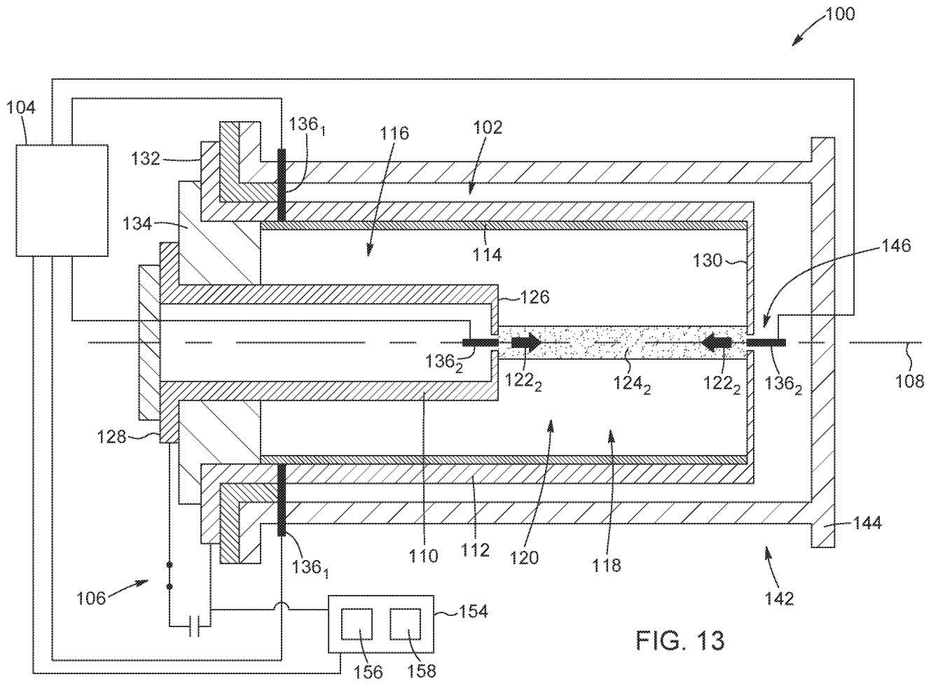

Other non-limiting examples of possible configurations and arrangements for the removable insert 114 are depicted in FIGS. 9 to 13, which illustrate other embodiments of the plasma generation system 110 depicted in the second operation mode. From FIG. 8 and these other embodiments, it is appreciated that, depending on the application, the removable insert 114 may be configured to contact only an outer peripheral surface of the inner electrode 110 (FIG. 12), only an inner peripheral surface of the outer electrode 112 (FIG. 13), or both an outer peripheral surface of the inner electrode 110 and an inner peripheral surface of the outer electrode 112 (FIGS. 9 to 11). It is also appreciated that the removable insert 114 may be configured to occupy either an entirety of the acceleration region 116 (FIGS. 8 to 10) or only a portion of the acceleration region 116 (FIGS. 11 to 13). Furthermore, the removable insert 114 may be configured to extend only in the acceleration region 116 (FIGS. 10 and 12) or both in the acceleration region 116 and the assembly region 118 (FIGS. 8, 9, 11, and 13). The removable insert 114 may be formed as a single integral unit or body of electrically insulating material (FIGS. 8 to 10, 12, and 13) or may include multiple physically disconnected parts of electrically insulating material (FIG. 11). It is appreciated that all of these configurations and arrangements for the removable insert 114 can be used to reduce the available discharge volume of the plasma chamber 120 to substantially exclude the acceleration region 116, such that the Z-pinch formation in the second operation mode of the plasma generation system 100 can occur predominantly or only in the assembly region 118.

Returning to FIG. 8, in the second operation mode, the precursor supply unit 104 is configured to supply a second plasma precursor 122₂ in the assembly region 118, within the available discharge volume of the plasma chamber 120. The assembly region 118 is configured to receive the second plasma precursor 122₂ from the precursor supply unit 104 via one or more second precursor supply ports 136₂ formed through either or both of the inner electrode 110 and the outer electrode 112. In the embodiment of FIG. 8, the precursor supply unit 104 is depicted as including two second precursor supply ports 136₂, one being formed through the front end 126 of the inner electrode 110 and the other one being formed through the front end 130 of the outer electrode 112, both of which at locations near the longitudinal axis 108. However, depending on the application, the one or more second precursor supply ports 136₂ may be formed only through the inner electrode 110, only through the outer electrode 112, or through both the inner electrode 110 and the outer electrode 112. It is appreciated that the number of second precursor supply port 136₂ and their longitudinal, azimuthal, and radial arrangements with respect to the assembly region 118 can be varied to suit the needs or preferences of a particular application. Furthermore, different second precursor supply ports 136₂ may be configured to supply second plasma precursors of different types and/or having different properties and parameters

Referring still to FIG. 8, the power supply unit 106 is configured to apply a discharge driving signal (e.g., a discharge voltage) to the inner electrode 110 and the outer electrode 112 to energize the second plasma precursor 122₂ into a second Z-pinch plasma 124₂ that extends longitudinally in the assembly region 118. The operation of the power supply unit 106 may be selected in view of the nature and parameters of the second plasma precursor 122₂ injected inside the assembly region 118, and the configuration and operating conditions of the plasma confinement device 102 in order to favor the formation of the second Z-pinch plasma 124₂ from the second plasma precursor 122₂.

In some embodiments, the operation of applying the discharge driving signal by the power supply unit 106 can be initiated after initiating the operation of supplying the second plasma precursor 122₂ into the assembly region 118 by the precursor supply unit 104. For example, in some embodiments, the operation of applying the discharge driving signal can be initiated with a time delay ranging from about 1 ns to about 20 ms after the operation of supplying the second plasma precursor 122₂ into the assembly region 118. However, in other embodiments, the operation of applying the discharge driving signal can be initiated before or at the same time as initiating the process supplying the second plasma precursor 122₂

into the assembly region 118.

In some embodiments, the precursor supply unit 104 may be configured to supply the second plasma precursor 122₂ as a neutral or partially (e.g., weakly) ionized gas or gas mixture. In such embodiments, the formation of the second Z-pinch plasma 124₂ can involve the ionization of the second plasma precursor 122₂ into an initial plasma and the compression of the initial plasma into the second Z-pinch plasma 124₂.

In other embodiments, the precursor supply unit 104 may be configured to supply the second plasma precursor 122₂ as an already-formed plasma. For example, the precursor supply unit 104 may be configured to form a second precursor plasma 122₂ outside the assembly region 118 and inject the second precursor plasma 122₂ into the assembly region 118 via the one or more second precursor supply ports 136₂. The second precursor plasma 122₂ thus injected can be energized and compressed into the second Z-pinch plasma 124₂ in the assembly region 118. In such embodiments, the second Z-pinch plasma 124₁ can be formed as a result of two decoupled and separately controlled processes: (i) a plasma formation and injection process, and (ii) a plasma acceleration and compression process. Such embodiments can provide enhanced control over the Z-pinch parameters and properties (e.g., plasma density, temperature, velocity, magnetic field, lifetime, and the like). As noted above with respect to the first operation mode, it is appreciated that, in such embodiments, the precursor supply unit 104 may include various types of plasma sources and plasma formation and injection techniques to form the second precursor plasma 122₂ and inject the second precursor plasma 122₂ into the assembly region 118.

In yet other embodiments, the precursor supply unit 104 may be configured to supply the second plasma precursor 122₂ as a mixture of neutral or partially (e.g., weakly) ionized gas and plasma.

Depending on the application, the second Z-pinch plasma 124₂ may or may not be sheared-flow stabilized. In some embodiments, a sheared flow can be embedded in the second Z-pinch plasma 124₂ by providing the precursor supply unit 104 with at least two second precursor supply ports 136₂, where the at least two second precursor supply ports 136₂ are configured to supply the second plasma precursor 122₂ in the assembly region 118 with at least two different velocity profiles and from at least two radial positions with respect to the longitudinal axis 108, so as to generate the second Z-pinch plasma 124₂ with an embedded sheared axial flow. Non-limiting examples of techniques for injecting an initial plasma with a radially sheared velocity profile into a plasma chamber and compressing the injected initial plasma into a Z-pinch plasma with an embedded sheared axial flow are disclosed in International Patent Application PCT/US2022/0125022 filed Jan. 14, 2022 and published as WO 2022/155462 on Jul. 21, 2022, the contents of which are incorporated herein by reference in their entirety. However, in other applications, the plasma generation system 100 may be configured to generate the second Z-pinch plasma 124₂ without a radial velocity shear (e.g., as a linear Z-pinch with a purely axial flow).

In some embodiments, the plasma generation system 100 may be configured to compress the second Z-pinch plasma 124₂ sufficiently to reach fusion conditions, that is, plasma temperature and density conditions at which fusion reactions can occur inside the second Z-pinch plasma 124₂. In such embodiments, the output energy produced by the fusion reactions, which typically involve the generation of neutrons, exceeds the input energy required to establish fusion conditions. In fusion power applications, the output energy can be converted into electricity.

In some embodiments, the plasma generation system 100 may include a vacuum system 142. The vacuum system 142 includes a vacuum chamber 144, for example, a pressure vessel or tank (e.g., made of stainless steel). The vacuum chamber 144 may be configured to contain, at least partially, various components of the plasma generation system 100, including at least part of the inner electrode 110 and the outer electrode 112. The vacuum chamber 144 may include various ports, for example, to allow the precursor supply unit 104 to be coupled to the interior of the plasma chamber 120. The vacuum system 142 may also include a pressure control system (not shown) configured to control the operating pressure inside the vacuum chamber 144. In some embodiments, the pressure inside the vacuum chamber 144 may range from about 10⁻⁹ Torr to about 20 Torr, although other ranges of pressure may be used in other embodiments,

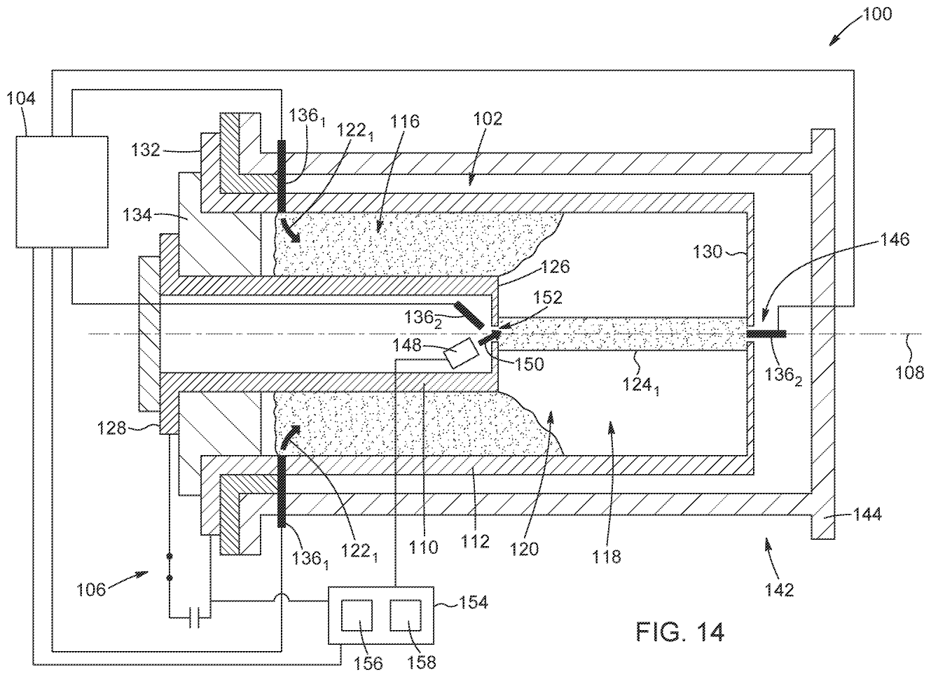

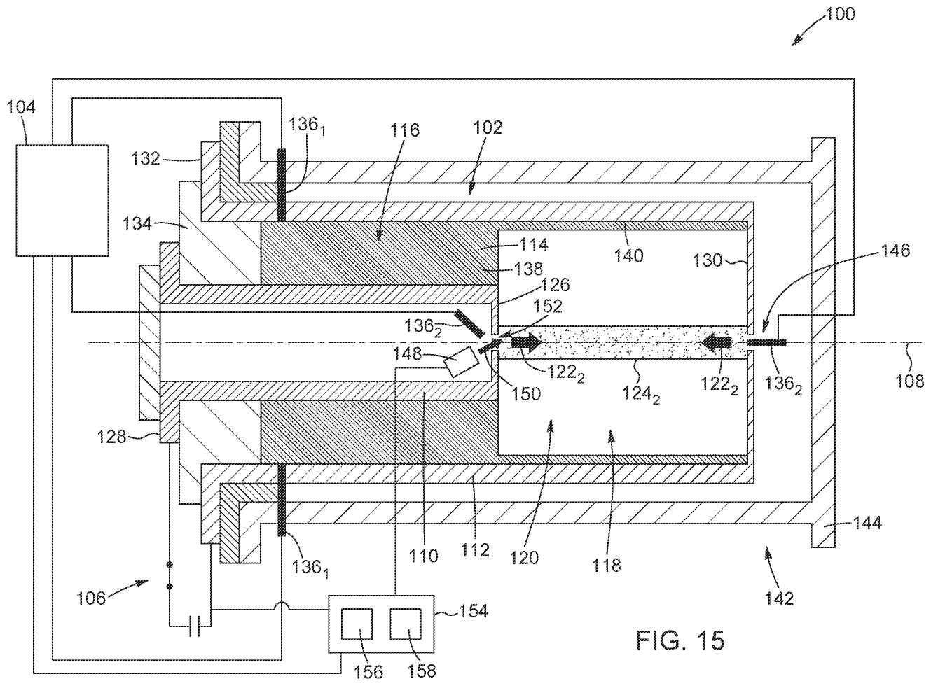

Referring to FIGS. 14 and 15, there are illustrated schematic longitudinal cross-sectional views of a plasma generation system 100, in accordance with another embodiment, where FIG. 14 depicts the system 100 in a first operation mode and FIG. 15 depicts the system 100 in a second operation mode. The embodiment of FIGS. 14 and 15 shares several features with the embodiment of FIGS. 7 and 8, which need not be described again other than to highlight differences between them. In FIGS. 14 and 15, the plasma generation system 100 includes a neutral beam injection (NBI) unit 148 configured to generate a beam 150 of neutral particles and inject the beam 150 of neutral particles into the plasma chamber 120 to heat, enhance, supplement, and/or stabilize the first and/or second Z-pinch plasmas 124₁, 124₂. In particular, the neutral particles can be coupled inside the first and/or second Z-pinch plasmas 124₁, 124₂ for heating and current drive. It is appreciated that, depending on the application, the NBI unit 148 may be used in either or both of the first and second operation modes.

NBI is method in which a beam of high-energy neutral particles is supplied and coupled to a plasma to provide heating and fueling. Being chargeless, the neutral atoms can enter the magnetic confinement field and be ionized via collisions with the ions and electrons in the plasma. The ionized particles thus generated are retained in the magnetic confinement field and are able to transfer their energy to the plasma ion and electrons. In the illustrated embodiment, using NBI can provide heating, momentum, fueling, and current drive to the first and/or second Z-pinch plasmas 124₁, 124₂, which can allow higher fusion power gain to be achieved and sustained over longer periods of time, with reduced or better controlled power losses and other energy inefficiencies.

In some embodiments, the NBI unit 148 can include an ion source (e.g., a plasma source) configured to produce an ion beam, which can be positive-ion beam or a negative-ion beam, an accelerator (e.g., an electrostatic accelerator) configured to accelerate the ion beam, a neutralizer (e.g. a gas-cell neutralizer) configured to partly or fully neutralize the accelerated ion beam, and a residual ion dump configured to separate (e.g., using magnets) remaining ions from neutrals to produce the neutral beam 150. The neutral beam 150 can be injected in the plasma confinement device 102 to couple into the first and/or second Z-pinch plasmas 124₁, 124₂ using any suitable methods. Being chargeless, the particles forming the neutral beam 150 can enter the magnetic confinement field of the first and/or second Z-pinch plasmas 124₁, 124₂, where they can heat and fuel the first and/or second Z-pinch plasmas 124₁, 124₂ via collisions with the plasma species. It is appreciated that the theory, configuration, implementation, and operation of NBI techniques as a plasma heating method are generally known in the art and need not be described in detail herein other than to facilitate an understanding of the present techniques.

The neutral particles forming the neutral beam 150 may include any suitable particles suitable for use in NBI. In some embodiments, the neutral beam 150 may include isotopes of hydrogen (e.g., protium, deuterium, or a mixture of deuterium and tritium). Other possible examples include helium-3 and boron-11. The beam power and the average neutral particle energy can be adjusted based on the density and the temperature of the first and/or second Z-pinch plasmas 124₁, 124₂.

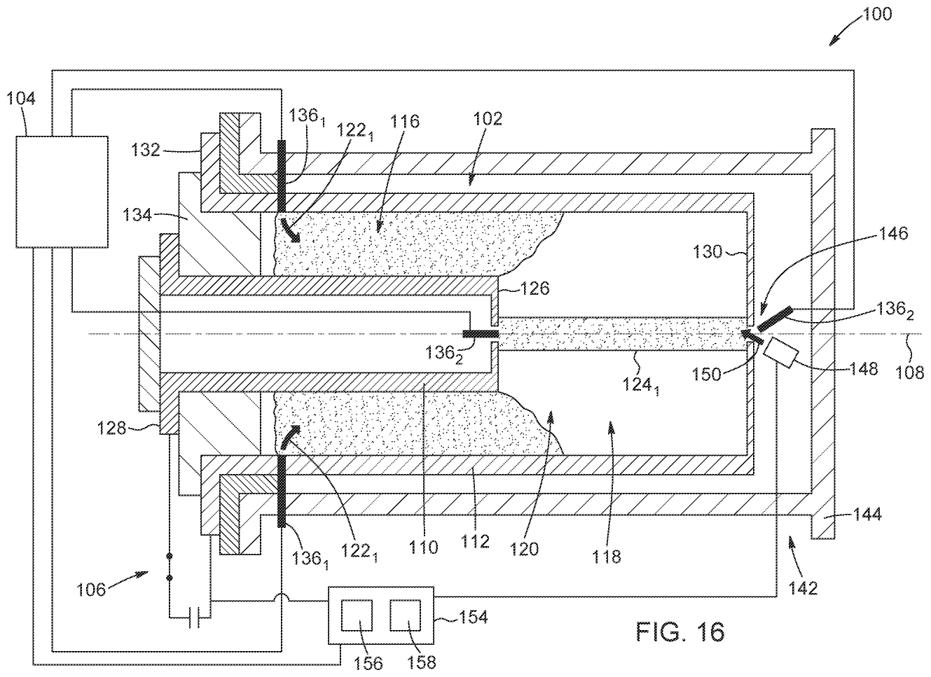

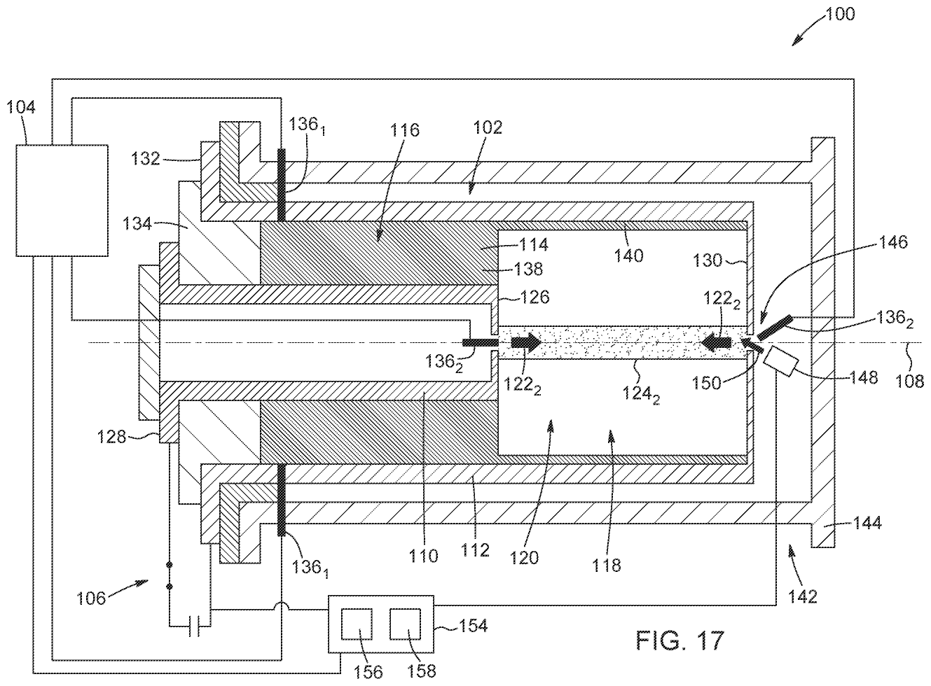

The neutral beam 150 may be injected into the first and/or second Z-pinch plasmas 124₁, 124₂ from any suitable location of the plasma confinement device 102 and through any suitable mode of injection. For example, in the embodiment of FIGS. 14 and 15, the NBI unit 148 is provided inside the inner electrode 110, and the neutral beam 150 is injected into the first and/or second Z-pinch plasmas 124₁, 124₂ via an NBI port 152 formed through the front end 126 of the inner electrode 110. Other arrangements are possible. For example, in the embodiment of FIGS. 16 and 17, the NBI unit 148 is provided outside the plasma confinement device 102, and the neutral beam 106 is injected into the first and/or second Z-pinch plasmas 124₁, 124₂ via an NBI port 152 formed through a front endwall at the front end 130 of the outer electrode 112. In yet other embodiments, a neutral beam 150 may be injected into the first and/or second Z-pinch plasmas 124₁, 124₂ from both within the inner electrode 110 and outside the outer electrode 112.

Depending on the application, a given NBI port 152 may be located either on the longitudinal axis 108, so that the injection angle between the NBI direction and the longitudinal axis 108 is substantially equal to zero, or radially offset from the longitudinal axis 108, so that the injection angle between the NBI direction and the Z-pinch axis is different from zero. In some embodiments, the neutral beam 150 may be shaped (e.g., in terms of its cross-sectional shape and/or size), directed (e.g., focused toward a certain focal point within the plasma chamber 120 or injected at a certain divergence angle), or otherwise conditioned as it propagates toward the first and/or second Z-pinch plasmas 124₁, 124₂. Beam conditioning can be performed in order to increase the efficiency with which the neutral beam 150 couples into the first and/or second Z-pinch plasmas 124₁, 124₂, and in turn to provide better control over the heating provided by the neutral beam 150 and its impact on the Z-pinch lifetime and properties. In general, it is appreciated that various NBI configurations are contemplated for use in the present techniques. In particular, the structure, configuration, and operation of the NBI unit 148, along with the NBI port number and location may be varied in accordance with the application.

It is appreciated that the embodiments of FIGS. 14 to 17 are provided by way of example only, and that the present techniques contemplate using NBI for plasma heating in various other types of Z-pinch plasma generation systems, in both fusion and non-fusion applications. For example, the embodiments depicted in FIGS. 9 to 13 may be adapted for using NBI in some applications. It is also appreciated that, in some embodiments, NBI can be replaced with, or supplemented by, ion beam injection to heat and stabilize the Z-pinch plasma 124.

Returning to FIGS. 7 and 8, the plasma generation system 100 can further include a control and processing unit 154 configured to control, monitor, and/or coordinate the functions and operations of various system components (e.g., the plasma confinement device 102, the precursor supply unit 104, and the power supply unit 106), as well as various operating conditions (e.g., temperature, pressure, flow rate, and power conditions). The control and processing unit 154 can be implemented in hardware, software, firmware, or any combination thereof, and may be connected to various components of the plasma generation system 100 via wired and/or wireless communication links to send and/or receive various types of signals (e.g., timing and control signals, measurement signals, and data signals). The control and processing unit 154 may be controlled by direct user input and/or by programmed instructions, and may include an operating system for controlling and managing various functions of the plasma generation system 100. Depending on the application, the control and processing unit 154 may be fully or partly integrated with, or physically separate from, the other hardware components of the plasma generation system 100. The control and processing unit 154 can include a processor 156 and a memory 158.

The processor 156 can implement operating systems, and may be able to execute computer programs, also known as commands, instructions, functions, processes, software codes, executables, applications, and the like. While the processor 156 is depicted in FIGS. 7 and 8 as a single entity for illustrative purposes, the term “processor” should not be construed as being limited to a single processing entity, and accordingly, any known processor architecture may be used. In some embodiments, the processor 156 may include a plurality of processing entities. Such processing entities may be physically located within the same device, or the processor 156 may represent the processing functionalities of a plurality of devices operating in coordination. For example, the processor 156 may include or be part of one or more of a computer; a microprocessor; a microcontroller; a coprocessor; a central processing unit (CPU); a special-purpose programmable logic device embodied in hardware device, such as, for example, a field-programmable gate array (FPGA) or an application-specific integrated circuit (ASIC); a digital processor; an analog processor; and/or other mechanisms configured to electronically process information and to operate collectively as a processor.

The memory 158, which may also be referred to as a “computer readable storage medium” or a “computer readable memory” is configured to store computer programs and other data to be retrieved by the processor 156. The terms “computer readable storage medium” and “computer readable memory” refer herein to a non-transitory and tangible computer product that can store and communicate executable instructions for the implementation of various steps of the techniques disclosed herein. The memory 158 may be any computer data storage device or assembly of such devices, including a random-access memory (RAM); a dynamic RAM; a read-only memory (ROM); a magnetic storage device; an optical storage device; a flash drive memory; and/or any other non-transitory memory technologies. The memory 158 may be associated with, coupled to, or included in the processor 156, and the processor 156 may be configured to execute instructions contained in a computer program stored in the memory 158 and relating to various functions and operations associated with the processor 156. While the memory 158 is depicted in FIGS. 7 and 8 as a single entity for illustrative purposes, the term “memory” should not be construed as being limited to a single memory unit, and accordingly, any known memory architecture may be used. In some embodiments, the memory 158 may include a plurality of memory units. Such memory units may be physically located within the same device, or the memory 158 can represent the functionalities of a plurality of devices operating in coordination.

The plasma generation system 100 may also include one or more user interface devices (not shown) operatively connected to the control and processing unit 154 to allow the input of commands and queries to the plasma generation system 100, as well as present the outcomes of the commands and queries. The user interface devices can include input devices (e.g., a touch screen, a keypad, a keyboard, a mouse, a switch, and the like) and output devices (e.g., a display screen, a printer, visual and audible indicators and alerts, and the like).

The following aspects are also disclosed herein:

1. A plasma generation system comprising:
a plasma confinement device having a longitudinal axis and comprising:
   an inner electrode;
   an outer electrode surrounding the inner electrode and defining an acceleration region therebetween, the outer electrode extending beyond the inner electrode along the longitudinal axis to define an assembly region adjacent the acceleration region, the acceleration region and the assembly region forming a plasma chamber; and
   an electrically insulating insert configured for removable insertion in the plasma chamber;
a precursor supply unit coupled to the plasma chamber; and
a power supply unit coupled to the inner electrode and the outer electrode,
wherein the plasma generation system is configured for operation in a first operation mode and a second operation mode,
wherein, in the first operation mode:
   the electrically insulating insert is removed from the plasma chamber;
   the precursor supply unit is configured to supply a first plasma precursor in the acceleration region; and
   the power supply unit is configured to energize the first plasma precursor to cause a plasma flow to move along the acceleration region and into the assembly region and to be compressed into a first Z-pinch plasma extending along the longitudinal axis in the assembly region, and
wherein, in the second operation mode:
   the electrically insulating insert is inserted in the plasma chamber and arranged with respect to the inner electrode and the outer electrode to reduce an available discharge volume of the plasma chamber to substantially exclude the acceleration region;
   the precursor supply unit is configured to supply a second plasma precursor in the assembly region, within the available discharge volume of the plasma chamber; and
   the power supply unit is configured to energize the second plasma precursor into a second Z-pinch plasma extending along the longitudinal axis in the assembly region.
      2. The plasma generation system of aspect 1, wherein the electrically insulating insert is made of a single integral body of electrically insulating material.
      3. The plasma generation system of aspect 1, wherein the electrically insulating insert is made of multiple physically disconnected parts of electrically insulating material.
      4. The plasma generation system of any one of aspects 1 to 3, wherein the electrically insulating insert is configured, upon insertion in the plasma chamber, to contact an outer peripheral surface of the inner electrode.
      5. The plasma generation system of any one of aspects 1 to 3, wherein the electrically insulating insert is configured, upon insertion in the plasma chamber, to contact an inner peripheral surface of the outer electrode.
      6. The plasma generation system of any one of aspects 1 to 3, wherein the electrically insulating insert is configured, upon insertion in the plasma chamber, to contact both an outer peripheral surface of the inner electrode and an inner peripheral surface of the outer electrode.
      7. The plasma generation system of any one of aspects 1 to 3, wherein the electrically insulating insert is configured, upon insertion in the plasma chamber, to occupy an entirety of the acceleration region.
      8. The plasma generation system of any one of aspects 1 to 7, wherein the electrically insulating insert is shaped as an annular cylinder.
      9. The plasma generation system of aspect 8, wherein the electrically insulating insert comprises a first annular segment and a second annular segment, wherein, upon insertion of the electrically insulating insert in the plasma chamber, the first annular segment is configured to occupy an entirety of the acceleration region and the second annular segment is configured to occupy an outer portion of the assembly region.
      10. The plasma generation system of aspect 9, wherein an inner radius of the first annular segment is smaller than an inner radius of the second annular segment, and wherein an outer radius of the first annular segment is equal to an outer radius of the second annular segment.
      11. The plasma generation system of any one of aspects 1 to 10, wherein the electrically insulating insert is made of a ceramic material, a glass material, a glass-ceramic material, a polymer material, or any combination thereof.
      12. The plasma generation system of any one of aspects 1 to 11, wherein the precursor supply unit is configured to supply the first plasma precursor in the acceleration region via one or more first precursor supply ports formed through a periphery of the inner electrode and/or a periphery of the outer electrode.
      13. The plasma generation system of any one of aspects 1 to 12, wherein the precursor supply unit is configured to supply the second plasma precursor in the assembly region via one or more second precursor supply ports formed through a front end of the inner electrode and/or a front end of the outer electrode.
      14. The plasma generation system of any one of aspects 1 to 13, wherein the first Z-pinch plasma and/or the second Z-pinch plasma have an embedded radially sheared axial flow.
      15. The plasma generation system of any one of aspects 1 to 14, wherein the first plasma precursor is a first precursor gas, and the second plasma precursor is a second precursor gas.
      16. The plasma generation system of any one of aspects 1 to 14, wherein the first plasma precursor is a first precursor plasma, and the second plasma precursor is a second precursor plasma.
      17. The plasma generation system of any one of aspects 1 to 16, wherein the first plasma precursor and the second plasma precursor comprise deuterium, tritium, hydrogen, helium, or any combination thereof.
      18. The plasma generation system of any one of aspects 1 to 17, further comprising a neutral beam injection unit configured to generate a beam of neutral particles and inject the beam of neutral particles into the plasma chamber to heat and stabilize the first Z-pinch plasma, in the first operation mode, and the second Z-pinch plasma, in the second operation mode.
      19. A method of controlling a plasma generation system having a first operation mode and a second operation mode, wherein the plasma generation system comprises a plasma confinement device having a longitudinal axis and comprising an inner electrode, an outer electrode surrounding the inner electrode to define an acceleration region therebetween, the outer electrode extending beyond the inner electrode along the longitudinal axis to define an assembly region adjacent the acceleration region, the acceleration region and the assembly region forming a plasma chamber, and an electrically insulating insert configured for removable insertion in the plasma chamber; a precursor supply unit coupled to the plasma chamber; and a power supply unit coupled to the inner electrode and the outer electrode, the method comprising:
operating the plasma generation system in the first operation mode, wherein the electrically insulating insert is removed from the plasma chamber, the operating comprising:
   supplying, with the precursor supply unit, a first plasma precursor in the acceleration region; and
   energizing, with the power supply unit, the first plasma precursor supplied in the acceleration region to cause a plasma flow to move along the acceleration region and into the assembly region and to be compressed into a first Z-pinch plasma extending along the longitudinal axis in the assembly region;
operating the plasma generation system in the second operation mode, wherein the electrically insulating insert is inserted into the plasma chamber and arranged with respect to the inner electrode and the outer electrode to reduce an available discharge volume of the plasma chamber to substantially exclude the acceleration region, the operating comprising:
   supplying, with the precursor supply unit, a second plasma precursor in the assembly region, within the available discharge volume of the plasma chamber; and
   energizing, with the power supply unit, the second plasma precursor supplied in the assembly region into a second Z-pinch plasma extending along the longitudinal axis in the assembly region; and
switching between operating the plasma generation system in the first operation mode and operating the plasma generation system in the second operation by selectively inserting the electrically insulating insert into or removing the electrically insulating insert from the plasma chamber.
   20. The method of aspect 19, further comprising providing the electrically insulating insert as a single integral body of electrically insulating material.
   21. The method of aspect 19, further comprising providing the electrically insulating insert as multiple physically disconnected parts of electrically insulating material.
   22. The method of any one of aspects 19 to 21, wherein inserting the electrically insulating insert in the plasma chamber comprises disposing the electrically insulating insert in contact with an outer peripheral surface of the inner electrode.
   23. The method of any one of aspects 19 to 21, wherein inserting the electrically insulating insert in the plasma chamber comprises disposing the electrically insulating insert in contact with an inner peripheral surface of the outer electrode.
   24. The method of any one of aspects 19 to 21, wherein inserting the electrically insulating insert in the plasma chamber comprises disposing the electrically insulating insert in contact with both an outer peripheral surface of the inner electrode and an inner peripheral surface of the outer electrode.
   25. The method of any one of aspects 19 to 21, wherein inserting the electrically insulating insert in the plasma chamber comprises making the electrically insulating insert occupy an entirety of the acceleration region.
   26. The method of any one of aspects 19 to 25, further comprising providing the electrically insulating insert as an annular cylinder.
   27. The method of aspect 26, further comprising providing the electrically insulating insert with a first annular segment and a second annular segment, wherein, upon insertion of the electrically insulating insert in the plasma chamber, the first annular segment is configured to occupy an entirety of the acceleration region and the second annular segment is configured to occupy an outer portion of the assembly region.
   28. The method of any one of aspects 19 to 27, wherein operating the plasma generation system comprises forming, in the first operation mode, the first Z-pinch plasma with an embedded radially sheared axial flow and/or forming, in the second operation mode, the second Z-pinch plasma with an embedded radially sheared axial flow.
   29. The method of any one of aspects 19 to 28, further comprising providing the first plasma precursor is a first precursor gas, and the second plasma precursor is a second precursor gas.
   30. The method of any one of aspects 19 to 28, further comprising providing the first plasma precursor is a first precursor plasma, and the second plasma precursor is a second precursor plasma.
   31. The method of any one of aspects 19 to 30, wherein the first plasma precursor and the second plasma precursor comprise deuterium, tritium, hydrogen, helium, or any combination thereof.
   32. The method of any one of aspects 19 to 31, further comprising, injecting a beam of neutral particles into the plasma chamber to heat and stabilize the first Z-pinch plasma, in the first operation mode, and the second Z-pinch plasma, in the second operation mode.

Numerous modifications could be made to the embodiments described above without departing from the scope of the appended claims.

1. A plasma generation system comprising:
a plasma confinement device having a longitudinal axis and comprising:
an inner electrode;
an outer electrode surrounding the inner electrode and defining an acceleration region therebetween, the outer electrode extending beyond the inner electrode along the longitudinal axis to define an assembly region adjacent the acceleration region, the acceleration region and the assembly region forming a plasma chamber; and
an electrically insulating insert configured for removable insertion in the plasma chamber;
a precursor supply unit coupled to the plasma chamber; and
a power supply unit coupled to the inner electrode and the outer electrode,
wherein the plasma generation system is configured for operation in a first operation mode and a second operation mode,
wherein, in the first operation mode:
the electrically insulating insert is removed from the plasma chamber;
the precursor supply unit is configured to supply a first plasma precursor in the acceleration region; and
the power supply unit is configured to energize the first plasma precursor to cause a plasma flow to move along the acceleration region and into the assembly region and to be compressed into a first Z-pinch plasma extending along the longitudinal axis in the assembly region, and
wherein, in the second operation mode:
the electrically insulating insert is inserted in the plasma chamber and arranged with respect to the inner electrode and the outer electrode to reduce an available discharge volume of the plasma chamber to substantially exclude the acceleration region;
the precursor supply unit is configured to supply a second plasma precursor in the assembly region, within the available discharge volume of the plasma chamber; and
the power supply unit is configured to energize the second plasma precursor into a second Z-pinch plasma extending along the longitudinal axis in the assembly region.

2. The plasma generation system of claim 1, wherein the electrically insulating insert is made of a single integral body of electrically insulating material.

3. The plasma generation system of claim 1, wherein the electrically insulating insert is made of multiple physically disconnected parts of electrically insulating material.

4. The plasma generation system of claim 1, wherein the electrically insulating insert is configured, upon insertion in the plasma chamber, to contact an outer peripheral surface of the inner electrode.

5. The plasma generation system of claim 1, wherein the electrically insulating insert is configured, upon insertion in the plasma chamber, to contact an inner peripheral surface of the outer electrode.

6. The plasma generation system of claim 1, wherein the electrically insulating insert is configured, upon insertion in the plasma chamber, to contact both an outer peripheral surface of the inner electrode and an inner peripheral surface of the outer electrode.

7. The plasma generation system of claim 1, wherein the electrically insulating insert is configured, upon insertion in the plasma chamber, to occupy an entirety of the acceleration region.

8. The plasma generation system of claim 1, wherein the electrically insulating insert is shaped as an annular cylinder.

9. The plasma generation system of claim 8, wherein the electrically insulating insert comprises a first annular segment and a second annular segment, wherein, upon insertion of the electrically insulating insert in the plasma chamber, the first annular segment is configured to occupy an entirety of the acceleration region and the second annular segment is configured to occupy an outer portion of the assembly region.

10. The plasma generation system of claim 9, wherein an inner radius of the first annular segment is smaller than an inner radius of the second annular segment, and wherein an outer radius of the first annular segment is equal to an outer radius of the second annular segment.

11. The plasma generation system of claim 1, wherein the electrically insulating insert is made of a ceramic material, a glass material, a glass-ceramic material, a polymer material, or any combination thereof.

12. The plasma generation system of claim 1, wherein the precursor supply unit is configured to supply the first plasma precursor in the acceleration region via one or more first precursor supply ports formed through a periphery of the inner electrode and/or a periphery of the outer electrode.

13. The plasma generation system of claim 1, wherein the precursor supply unit is configured to supply the second plasma precursor in the assembly region via one or more second precursor supply ports formed through a front end of the inner electrode and/or a front end of the outer electrode.

14. The plasma generation system of claim 1, wherein the first Z-pinch plasma and/or the second Z-pinch plasma have an embedded radially sheared axial flow.

15. The plasma generation system of claim 1, wherein the first plasma precursor is a first precursor gas, and the second plasma precursor is a second precursor gas.

16. The plasma generation system of claim 1, wherein the first plasma precursor is a first precursor plasma, and the second plasma precursor is a second precursor plasma.

17. The plasma generation system of claim 1, wherein the first plasma precursor and the second plasma precursor comprise deuterium, tritium, hydrogen, helium, or any combination thereof.

18. The plasma generation system of claim 1, further comprising a neutral beam injection unit configured to generate a beam of neutral particles and inject the beam of neutral particles into the plasma chamber to heat and stabilize the first Z-pinch plasma, in the first operation mode, and the second Z-pinch plasma, in the second operation mode.

19. A method of controlling a plasma generation system having a first operation mode and a second operation mode, wherein the plasma generation system comprises a plasma confinement device having a longitudinal axis and comprising an inner electrode, an outer electrode surrounding the inner electrode to define an acceleration region therebetween, the outer electrode extending beyond the inner electrode along the longitudinal axis to define an assembly region adjacent the acceleration region, the acceleration region and the assembly region forming a plasma chamber, and an electrically insulating insert configured for removable insertion in the plasma chamber; a precursor supply unit coupled to the plasma chamber; and a power supply unit coupled to the inner electrode and the outer electrode, the method comprising:
operating the plasma generation system in the first operation mode, wherein the electrically insulating insert is removed from the plasma chamber, the operating comprising:
supplying, with the precursor supply unit, a first plasma precursor in the acceleration region; and
energizing, with the power supply unit, the first plasma precursor supplied in the acceleration region to cause a plasma flow to move along the acceleration region and into the assembly region and to be compressed into a first Z-pinch plasma extending along the longitudinal axis in the assembly region;
operating the plasma generation system in the second operation mode, wherein the electrically insulating insert is inserted into the plasma chamber and arranged with respect to the inner electrode and the outer electrode to reduce an available discharge volume of the plasma chamber to substantially exclude the acceleration region, the operating comprising:
supplying, with the precursor supply unit, a second plasma precursor in the assembly region, within the available discharge volume of the plasma chamber; and
energizing, with the power supply unit, the second plasma precursor supplied in the assembly region into a second Z-pinch plasma extending along the longitudinal axis in the assembly region; and
switching between operating the plasma generation system in the first operation mode and operating the plasma generation system in the second operation by selectively inserting the electrically insulating insert into or removing the electrically insulating insert from the plasma chamber.

20. The method of claim 19, further comprising providing the electrically insulating insert as a single integral body of electrically insulating material.

21. The method of claim 19, further comprising providing the electrically insulating insert as multiple physically disconnected parts of electrically insulating material.

22. The method of claim 19, wherein inserting the electrically insulating insert in the plasma chamber comprises disposing the electrically insulating insert in contact with an outer peripheral surface of the inner electrode.

23. The method of claim 19, wherein inserting the electrically insulating insert in the plasma chamber comprises disposing the electrically insulating insert in contact with an inner peripheral surface of the outer electrode.

24. The method of claim 19, wherein inserting the electrically insulating insert in the plasma chamber comprises disposing the electrically insulating insert in contact with both an outer peripheral surface of the inner electrode and an inner peripheral surface of the outer electrode.

25. The method of claim 19, wherein inserting the electrically insulating insert in the plasma chamber comprises making the electrically insulating insert occupy an entirety of the acceleration region.

26. The method of claim 19, further comprising providing the electrically insulating insert as an annular cylinder.

27. The method of claim 26, further comprising providing the electrically insulating insert with a first annular segment and a second annular segment, wherein, upon insertion of the electrically insulating insert in the plasma chamber, the first annular segment is configured to occupy an entirety of the acceleration region and the second annular segment is configured to occupy an outer portion of the assembly region.

28. The method of claim 19, wherein operating the plasma generation system comprises forming, in the first operation mode, the first Z-pinch plasma with an embedded radially sheared axial flow and/or forming, in the second operation mode, the second Z-pinch plasma with an embedded radially sheared axial flow.

29. The method of claim 19, further comprising providing the first plasma precursor is a first precursor gas, and the second plasma precursor is a second precursor gas.

30. The method of claim 19, further comprising providing the first plasma precursor is a first precursor plasma, and the second plasma precursor is a second precursor plasma.

31. The method of claim 19, wherein the first plasma precursor and the second plasma precursor comprise deuterium, tritium, hydrogen, helium, or any combination thereof.

32. The method of claim 19, further comprising, injecting a beam of neutral particles into the plasma chamber to heat and stabilize the first Z-pinch plasma, in the first operation mode, and the second Z-pinch plasma, in the second operation mode.
